(19) United States
(12) Patent Application Publication
(10) Pub. No.: US 2026/0330790 A1
(43) Pub. Date: Oct. 22, 2026

(54) TRANSITIONING DISPLAY OF VIRTUAL CONTENT BASED ON USER CONDITION

(71) Applicant: Apple Inc., Cupertino, CA (US)

(72) Inventors: Manuel C. CLEMENT, Felton, CA (US); Brian W. TEMPLE, Santa Clara, CA (US)

(21) Appl. No.: 19/571,881

(22) Filed: Mar. 19, 2026

Related U.S. Application Data
(60) Provisional application No. 63/792,127, filed on Apr. 21, 2025.

(51) Int. Cl. G06T 19/20; G06F 3/01

(52) U.S. Cl. CPC G06T 19/20; G06F 3/011; G06F 3/017; G06T 2219/2016

(57) ABSTRACT

Presented herein is a method performed at an electronic device in communication with one or more displays and one or more input devices. The electronic device displays, via the one or more displays, virtual content in a first display mode within a three-dimensional environment. While displaying the virtual content in the first display mode, the electronic device detects an indication corresponding to a request to modify a display mode of the virtual content. Then, in response to detecting the indication, the device displays the virtual content, via the one or more display generation components, in a second display mode, different from the first display mode, within the three-dimensional environment, wherein displaying the second display mode includes extending a size of a first dimension of the virtual content and maintaining a size of a second dimension of the virtual content.

### CROSS-REFERENCE TO RELATED APPLICATIONS

This application claims the benefit of U.S. Provisional Application No. 63/792,127, filed Apr. 21, 2025, the content of which is herein incorporated by reference in its entirety for all purposes.

### TECHNICAL FIELD

The present disclosure relates generally to computer systems that provide three-dimensional experiences, including, but not limited to, electronic devices that provide extended reality experiences via a display.

### BACKGROUND

The development of computer systems for extended reality has increased significantly in recent years. Example extended reality environments include at least some virtual elements that replace or augment the physical world. Input devices, such as cameras, controllers, joysticks, touch-sensitive surfaces, and touch-screen displays for computer systems and other electronic computing devices are used to interact with extended reality environments. Example virtual elements include virtual objects, such as digital images, video, text, icons, and control elements such as buttons and other graphics.

### SUMMARY

Some examples of the disclosure are directed to systems and methods for displaying virtual content in one or more display modes based on user condition and/or a condition associated with the virtual content. For example, a method is performed at an electronic device in communication with one or more displays and one or more input devices. In some examples, the electronic device displays, via the one or more displays, virtual content in a first display mode within a three-dimensional environment. In some examples, while displaying the virtual content in the first display mode, the electronic device detects an indication corresponding to a request to modify a display mode of the virtual content. In some examples, in response to detecting the indication, the electronic device displays the virtual content, via the one or more displays, in a second display mode, different from the first display mode, within the three-dimensional environment. In some examples, displaying the second display mode includes extending a size of a first dimension of the virtual content from a first size in the first display mode to a second size in the second display mode. In some examples, displaying the second display mode includes maintaining a size of a second dimension of the virtual content when displaying, via the one or more displays, virtual content in the second display mode within the three-dimensional environment.

### BRIEF DESCRIPTION OF THE DRAWINGS

For a better understanding of the various described examples, reference should be made to the Detailed Description below, in conjunction with the following drawings in which like reference numerals refer to corresponding parts throughout the figures.

FIG. 1 illustrates an electronic device presenting a three-dimensional environment according to some examples of the disclosure.

FIGS. 2A-2B illustrate block diagrams of example architectures for electronic devices according to some examples of the disclosure.

FIG. 3A illustrates example virtual content displayed within three-dimensional environment presented via one or more displays of an electronic device according to examples of the disclosure.

FIG. 3B illustrates an exemplary transition of the display of the virtual content from the first display mode to the second display mode according to examples of the disclosure.

FIG. 3C illustrates an example of the electronic device worn by a user, in which the display is displaying virtual content in a three-dimensional environment after the transition to the second display mode according to examples of the disclosure.

FIG. 3D illustrates an example of the electronic device worn by a user, in which the display is transitioning the display of the virtual content in a three-dimensional environment from the second display mode to a third display mode according to examples of the disclosure.

FIG. 3E illustrates an example of the electronic device worn by a user, in which the display is displaying the virtual content in a three-dimensional environment after the transition to the third display mode according to examples of the disclosure.

FIGS. 4A-4E illustrate multiple examples of the indications corresponding to requests to modify a display mode of the virtual content according to examples of the disclosure.

FIG. 5A illustrates an example of a gaming application in a three-dimensional environment in a second display mode according to examples of the disclosure.

FIG. 5B illustrates an example of a gaming application in a three-dimensional environment in a third display mode according to examples of the disclosure.

FIG. 5C illustrates an example of a gaming application in a three-dimensional environment in a third display mode while a user performs a hand gesture according to examples of the disclosure.

FIG. 5D illustrates an example of a gaming application in a three-dimensional environment in a second display mode according to examples of the disclosure.

FIG. 5E illustrates an example of a gaming application in a three-dimensional environment in a second display mode while a user performs a hand gesture according to examples of the disclosure.

FIG. 5F illustrates an example of a gaming application in a three-dimensional environment in a first display mode according to examples of the disclosure.

FIGS. 6A-6C illustrate a user turning away from the virtual content in a three-dimensional environment to change the display mode from the second display mode to the first display mode according to examples of the disclosure.

FIGS. 7A-7B illustrate another example of a user turning away from the virtual content in a three-dimensional environment to cease the display of the virtual content according to examples of the disclosure.

FIGS. 7C-7D show the display of the electronic device displaying the virtual content in the three-dimensional environment in the second display mode with visible areas between the virtual content and the edge of display according to examples of the disclosure.

FIG. 8 is a flow diagram illustrating an example method for transitioning the display based on user condition according to some examples of the disclosure.

### DETAILED DESCRIPTION

The present disclosure relates to user interfaces for providing an extended reality (XR) experience to a user in accordance with some examples of the disclosure. The systems, methods, and graphical user interfaces (GUIs) described herein improve user interface interactions with XR environments in multiple ways, including preventing or mitigating nausea or motion sickness for an XR experience.

In some examples, an electronic device in communication with one or more displays and one or more input devices. The electronic device is configured to display, via the one or more displays, virtual content in a first display mode within a three-dimensional environment. While displaying the virtual content in the first display mode, the device then detects an indication corresponding to a request to modify a display mode of the virtual content. In response to detecting the indication, the device displays the virtual content, via the one or more display generation components, in a second display mode, different from the first display mode, within the three-dimensional environment, wherein displaying the second display mode includes extending a size of a first dimension of the virtual content from a first size in the first display mode to a second size in the second display mode and maintaining a size of a second dimension of the virtual content when displaying, via the one or more displays, virtual content in the second display mode within the three-dimensional environment.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user selects a particular orientation for the three-dimensional object or the electronic device automatically selects the orientation for the three-dimensional object (e.g., based on a type of the three-dimensional object).

In some examples, a three-dimensional object can be displayed in the three-dimensional environment in an environment-locked orientation, a viewpoint-locked orientation, a tilt-locked orientation, or a head-locked orientation, as described below. In some examples, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

In some examples, an object that is displayed in a head-locked orientation in a three-dimensional environment has a distance and orientation offset relative to the user's head. In some examples, a head-locked object moves within the three-dimensional environment as the user's head moves (as a viewpoint of the user changes).

In some examples, an object that is displayed in an environment-locked orientation in a three-dimensional environment does not have a distance or orientation offset relative to the user.

In some examples, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

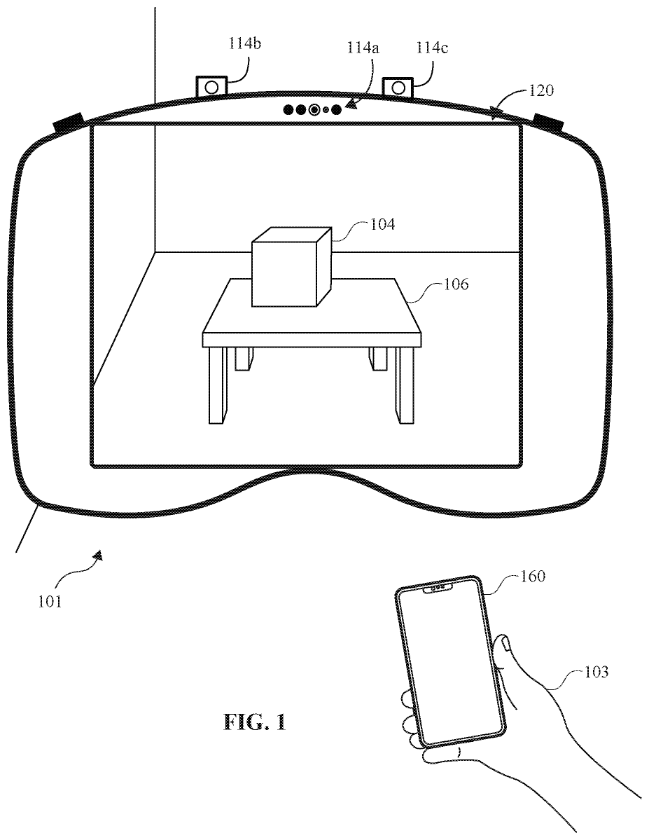

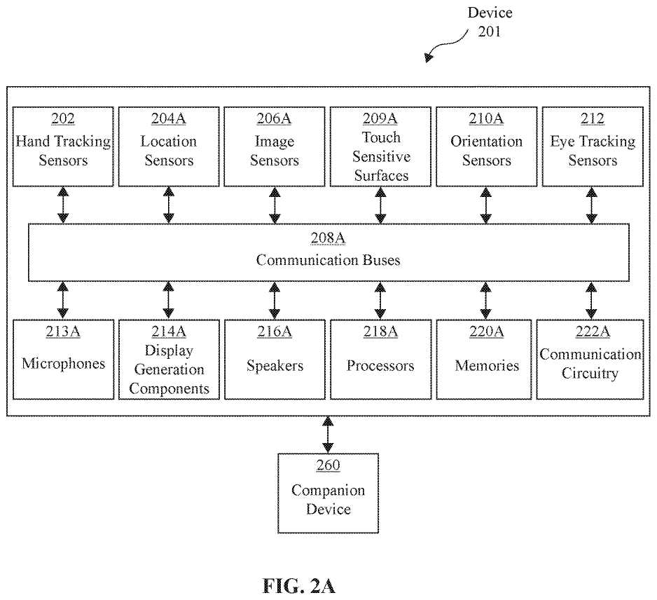

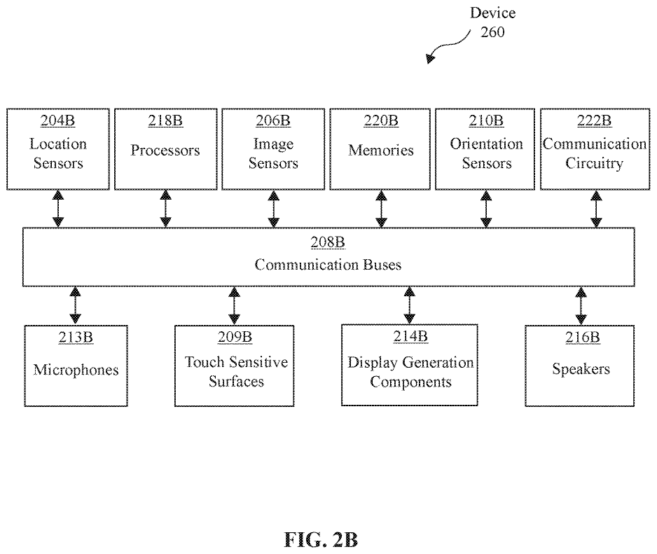

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specifies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101. Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display, and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260) but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards systems and methods for transitioning the display of virtual content on an electronic device into different immersion modes based on a condition of the user and/or a condition of the content being displayed.

Some electronic devices are configured to and capable of displaying virtual content within an XR three-dimensional environment that is presented via the electronic device. While displaying this virtual content within the three-dimensional environment, motion of elements within the virtual content being displayed can cause the user of the electronic device to experience a physiological response (e.g., nausea or sickness) because the motion the user sees via the display mismatches the motion (or lack of motion) of the user in the three-dimensional environment. To alleviate or relieve this physiological response, in some examples, the electronic device can predict or receive an indication when the virtual content is or is likely to be causing motion sickness and transition the current display of the virtual content to a different (e.g., less immersive) display that occupies a smaller portion of the viewport (e.g., field of view) of the user within the three-dimensional environment. Smaller virtual content and/or less immersion can reduce the physiological response. In some examples, some electronic devices (described further below) include one or more features to keep a user engaged and to dismiss content when the user is no longer engaged. As described herein, in some examples, an electronic device detects an indication and transitions the virtual content displayed from a first mode to a second mode, where the second mode expands at least one dimension of the virtual content compared to the virtual content displayed in the first mode. In some examples, expansion of the virtual content when transitioning between modes occurs in a predefined sequence. Further, in some examples, transitioning the content displayed to a more immersive display that occupies a larger field of view also helps reduce the physiological response.

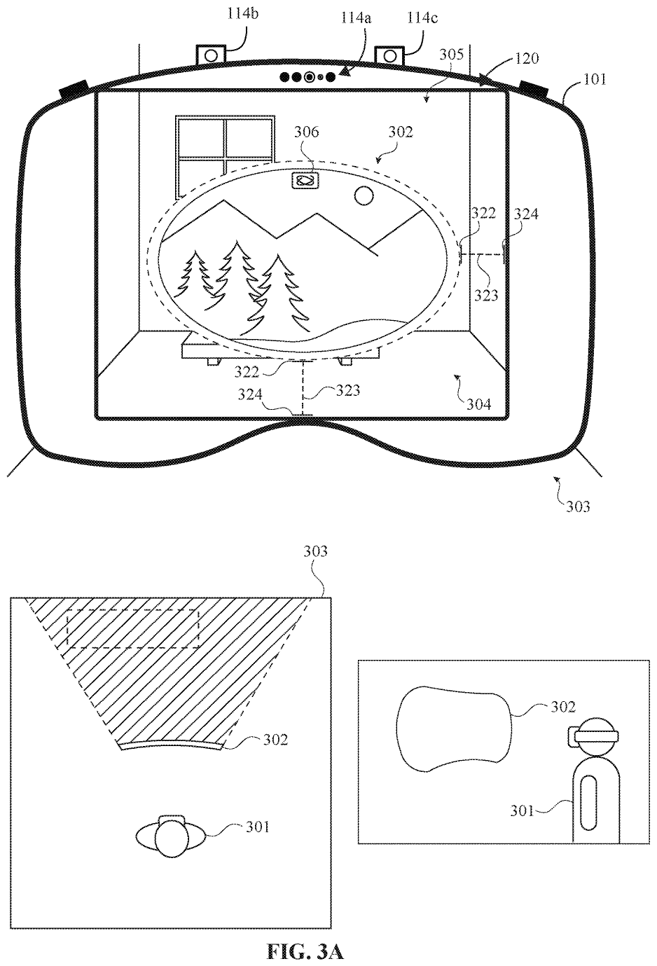

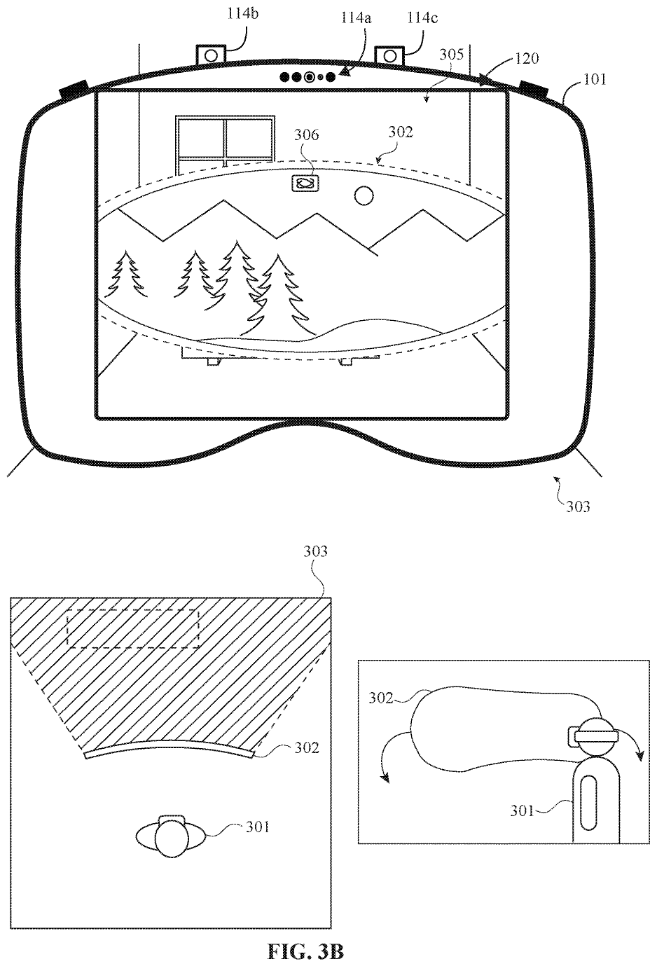

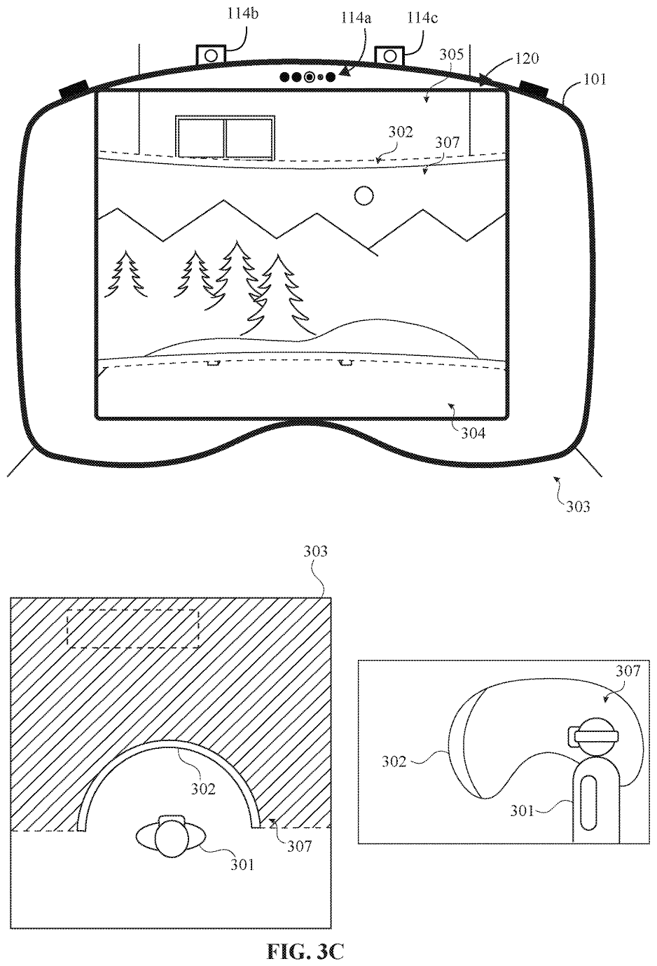

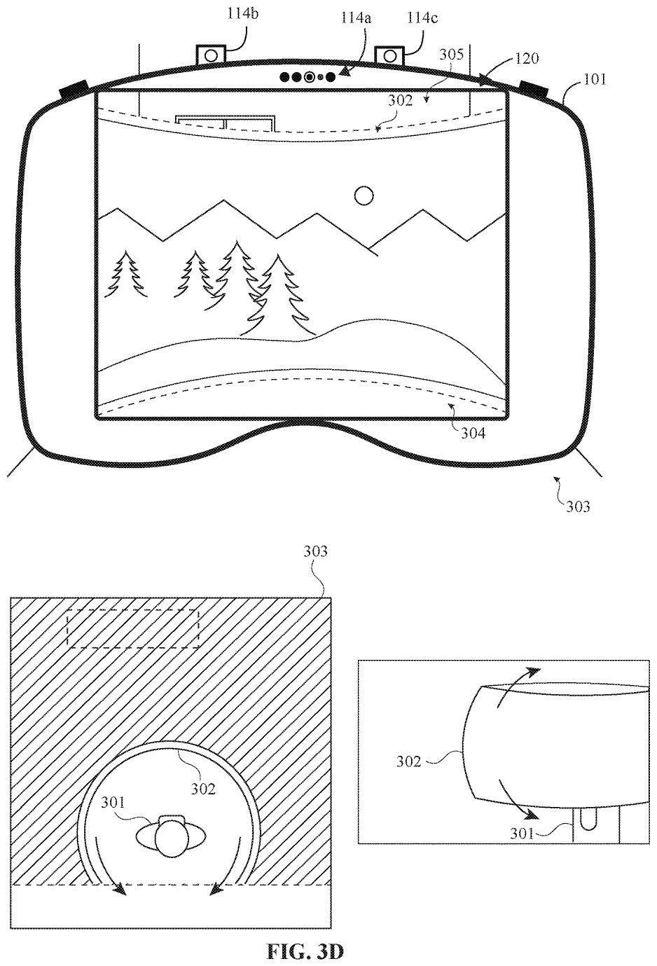

FIG. 3A illustrates an exemplary three-dimensional environment displayed on one or more displays of an electronic device according to examples of the disclosure. In some examples, electronic device 101 is a wearable device (e.g., such as a head-mounted device) that is worn by a user by a user 301. In some examples, and as illustrated in FIG. 3A, electronic device 101 includes display 120 that displays virtual content 302 in a three-dimensional environment 303. In some examples, three-dimensional environment 303 can be a representation of a physical real-world environment that surrounds electronic device 101 or can be a virtual environment. It is understood that the location of virtual content 302 is a non-limiting presentation of the location of the virtual content and that the virtual content can be simulated from one or more different locations within the display of the three-dimensional environment.

In some examples, the methods described herein are performed at an electronic device 101 in communication with one or more devices. Optionally, electronic device 101 can correspond to electronic device 201 or another device described herein that can display virtual content to a user. In some examples, electronic device 101 is a head-mounted device. In some examples, electronic device 101 is in communication with one or more displays. The one or more displays can be any display described herein. In some examples, electronic device 101 is in communication with one or more input devices. The one or more input devices can be any of the devices described herein configured to receive inputs including those from the user 301 or from sensing the three-dimensional environment 303. In some examples, electronic device 101 displays virtual content 302 via the one or more displays and can change the appearance of the virtual content 302 displayed depending on inputs received at the one or more input devices. In some examples, electronic device 101 is capable of displaying the virtual content 302 via the display 120 in the three-dimensional environment 303 in a wide variety of display modes with different dimensions and/or immersion levels.

FIG. 3A also depicts a bird-eye view (e.g., top-down view) of a three-dimensional environment 303, wherein the three-dimensional environment 303 is a representation of a physical environment surrounding the user 301. In some examples, the three-dimensional environment 303 in which the virtual content 302 is displayed can be an XR environment including a real world three-dimensional environment that remains in place, and is visible around the virtual content 302 in the three-dimensional environment 303. In some examples, the three-dimensional environment 303 can be any XR environment that remains in place and is visible around virtual content 302 in the three-dimensional environment 303. For example, the three-dimensional environment 303 can be a virtually created room. In some examples, three-dimensional environment is the real world three-dimensional environment surrounding user 301, and the cameras and sensors of electronic device 101 are used to capture and display representations of the real-world environment and/or present the real-world environment in real-time (e.g., passthrough video or optical see-through). While displaying virtual content 302 in three-dimensional environment 303, the user can interact with virtual content 302. As shown in FIG. 3A, the three-dimensional environment 303 is a room.

In some examples, electronic device 101 displays, via the one or displays, virtual content 302 in a three-dimensional environment 303. In some examples, virtual content 302 is an application that is displayed in the three-dimensional environment 303 in a separate window and/or screen. In some examples, virtual content 302 refers only to the application displayed in three-dimensional environment 303. In some examples, virtual content 302 fully immerses user 301 in the virtual content 302 and completely occludes three-dimensional environment 303 so that the virtual content 302 becomes the new environment in which user 301 is immersed and the three-dimensional environment 303 is thus not visible from any angle on electronic device 101. For example, the virtual content 302 can be a video application, game application, movie application, or any other suitable application, including media applications, in which content is displayed. In some examples, virtual content 302 is displayed as environment-locked, which means the location of the virtual content 302 stays fixed even while the user 301 moves around the three-dimensional environment 303. In some other examples, virtual content 302 is displayed as viewpoint-locked to maintain a fixed orientation with respect to user even when the user is moving within the three-dimensional (e.g., virtual) environment.

In some examples, electronic device 101 displays virtual content 302 in a first display mode 304. In some examples, the first display mode refers to a state of the display of virtual content 302, that includes a specific set of spatial characteristics. In some examples, and as described in further detail below, the set of spatial characteristics are used to configure the visual presentation of virtual content 302 in the three-dimensional environment 303 to user 301. When the content is being displayed in a specific type of context, the set of spatial characteristics define what the virtual content looks like and how it is presented to user 301 in that context. In some examples, the first display mode 304 includes a first set of spatial properties (e.g., spatial characteristics), that are optionally unique to first display mode 304. In some examples, spatial properties include any characteristic of virtual content 302 that affects the display of virtual content 302. For example, a spatial property can include a shape, a width, a height, a depth, a curvature, an orientation, an area, a volume, or any other property of the display of virtual content 302. In some examples, first display mode 304 is a floating window displayed in three-dimensional environment 303 that displays the virtual content 302 (e.g., floating within the three-dimensional environment). In some examples, the virtual content 302 is optionally cropped within the floating window. In some examples, first display mode 304 displays the content of virtual content 302 without cropping, but optionally scaled in size to fit the window size. In some examples, though each set of spatial properties is unique to its respective display mode, some display modes can share one or more spatial properties. For example, when transitioning into a different display mode (e.g., from a first set of spatial properties to a second set of spatial properties), one spatial property (e.g., the width) can be maintained whereas another spatial property (e.g., height) is changed (e.g., expanded). In some examples, first display mode 304 is a default display mode that is used when virtual content 302 does not satisfy one or more criteria that would cause the display mode to be in or transition to a second and/or third display mode, as explained in further detail below. The one or more criteria represent conditions that must be satisfied in order for electronic device 101 to perform a task, such as changing the display mode of virtual content 302, or another applicable task performed by electronic device 101 described herein.

As an example, as shown in FIG. 3A, first display mode 304 displays virtual content 302 in a circular or an ovular shape with a diameter (or an elliptical shape with a major axis and minor axis); this diameter is set as a spatial property of the virtual content 302 in the first display mode 304. For example, the diameter size can be defined based on the display size (e.g., virtual content 302 can occupy a percentage of the display width or area, e.g., half of the display width or area). Additionally or alternatively, the diameter of virtual content 302 when in the first display mode can be defined based on units of length (e.g., 1 cm, 5 cm, 10 cm, 20 cm, etc. wide). In some examples, when virtual content 302 is displayed in the first display mode 304, the content can be displayed in the center of the viewpoint of the user (e.g., the user's field of view). It is understood that, in some examples, the above parameters may be initial properties that are optionally adjustable to enable content to be presented at a different size, depth, offset from center, etc. Additionally, in another example, the electronic device 101 displays the virtual content in first display mode 304 as a two-dimensional display. Whether to display the virtual content in two-dimensional or three-dimensional form can be a spatial property as part of the first display mode 304. Optionally, virtual content 302 in the first display mode 304 is displayed as a two-dimensional flat window, a curved screen, a three-dimensional immersion portal, or any suitable user interface element, which can be a spatial property set to be associated with first display mode 304. In some examples, virtual content 302 is shown in a vertically expanding or horizontally expanding immersion portal. Furthermore, the first set of spatial properties are optionally preset by user 301 (prior to display of virtual content 302 in first display mode 304) or extracted from the virtual content 302 to be displayed. For example, the virtual content 302 displayed could be a cropped version of the center of the virtual content 302. In another example, the virtual content 302 displayed is a miniature version, or smaller frame, of the full version of the virtual content 302.

In some examples, virtual content 302 includes non-static content, such as movement within the virtual content 302 (e.g., video content and or gaming content that includes motion as the content is being displayed). In some examples, the movement of elements within virtual content 302 can cause user 301 to experience motion sickness and/or nausea when the motion user 301 views on electronic device 101 does not match the motion the body of user 301 is experiencing simultaneously. For example, when virtual content 302 is a movie, the movie could include scenes that have more than a threshold motion like a chase scene or an action scene. In another example, in a video game application, the motion may be caused by the game play of the user, or the context of the scene (e.g., flying an aircraft, or other high speed vehicle). In response to detecting a difference in velocity or acceleration of the user (e.g., as measured by one or more inertial measurement units (IMUs) or a presumed velocity or acceleration of the user) compared to the velocity or acceleration represented in virtual content 302 exceeds a threshold value, electronic device 101 modifies the display mode of virtual content 302 (described in further detail below). On the other hand, when the difference in velocity or acceleration of the user in the three-dimensional environment 303 compared to the velocity or acceleration represented by elements within virtual content 302 is below a threshold value, virtual content 302 continues to be displayed in the same display mode (e.g., in the first display mode). Additionally or alternatively, the threshold difference for velocity between elements in the virtual content 302 compared to the velocity of the user in the three-dimensional environment 303 can be defined in terms of speed (e.g., 10 mph, 15 mph, 20 mph, 30 mph, etc.). In some examples, the threshold difference value may be determined empirically based on proper research and investigation. In some examples, the virtual content 302 communicates the velocity of the elements within the virtual content 302 with electronic device 101. Therefore, in an example context in which the user 301 is stationary while the content is detected as moving at a simulated speed of above 20 mph, the electronic device 101 modifies the display mode of the content (described below) in order to prevent user 301 from experiencing motion sickness or other unfavorable physiological responses. In some examples, modifying the display of virtual content can include either shrinking or expanding the virtual content 302. In some examples, the shrinking and expansion of the display mode is reversed when the indications detected are reversed.

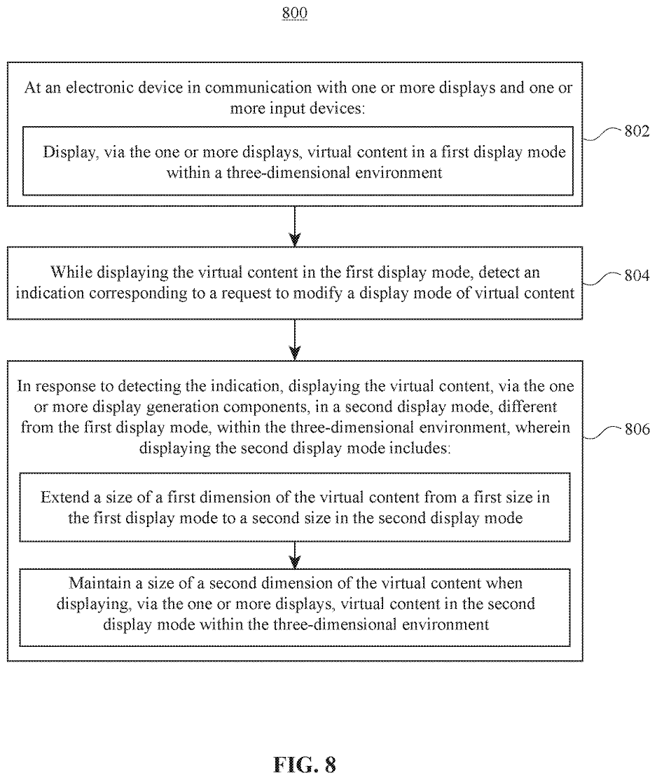

In some examples, first display mode 304 shows the virtual content 302 as being smaller than the field of view of the user of the electronic device 101, so the three-dimensional environment 303 is still visible in the areas 305 between the virtual content 302 and the edge of display 120. As shown in FIG. 3A, the edges 322 of virtual content 302 and the edges 324 of display 120 have a distance 323 between them, in which this distance 323 covers the areas 305 between the virtual content 302 and the edge of display 120. In some examples, the areas 305 are planar and only visible to the user 301 via the display 120. In some examples, area 305 is visible on both the top and bottom and the left and right sides of virtual content 302. In some other examples, areas 305 are only visible on either the top and bottom sides or the left and right sides of virtual content 302 between edges 322 of virtual content 302 and edges 324 of display 120. In some examples, area 305 allows user 301 to view the virtual or real-world environment (e.g., three-dimensional environment 303) as they are looking at and possibly interacting with virtual content 302 and also provide some room for head rotation without clipping the virtual content or entirely blocking view of the three-dimensional environment 303. In some examples, the visibility of areas 305 between the virtual content 302 and the edge of display 120 helps user 301 to avoid and/or alleviate experiencing motion sickness from the virtual content 302. This mode reduces motion sickness, as the user is still seeing a large portion of the real world around the content and the user is still provided peripheral vision adapted to the content the user is looking at. These areas 305 are explained in further detail with references to FIGS. 8A and 8B.

As described above, in some examples, the elements within virtual content 302 and/or the user 301 can indicate to electronic device 101 that user 301 is experiencing motion sickness (e.g., as described above). In some examples, electronic device 101, in response to detecting the indication of motion sickness (or other conditions) of the virtual content 302, can switch from a first display mode 304 to a second display mode 307, different from first display mode 304. In some examples, electronic device 101 detects or receives an indication to transition the virtual content 302 to a second mode, different from the first mode, so as to relieve and/or prevent user 301 from experiencing motion sickness. In some examples, transitioning from first to a second mode includes changing at least one spatial property, such as expanding at least a first dimension of the virtual content to increase immersion, which can help alleviate sickness caused by motion by balancing the view between the content and the actual/physical environment. In some examples, transitioning from first to a second mode includes changing at least one spatial property, such as shrinking at least a first dimension of the virtual content to decrease immersion, which can also help alleviate sickness caused by motion. The sickness caused by motion means there is a disparity between the motion the user is experiencing in the virtual content and the motion the user experiences in the physical environment. Thus, changing the display mode (e.g., shrinking or expanding) alleviates this disparity. At least a first dimension can be of the spatial properties explained herein and associated with first display mode 304.

In some examples, while displaying the virtual content in the first display mode, electronic device 101 detects or receives an indication corresponding to a request to modify a display mode of the virtual content 302. In some examples, as explained above, modifying the display mode of virtual content 302 includes expanding at least a first dimension of the first display mode 304. In some examples, as explained above, modifying the display mode of virtual content 302 includes shrinking at least a first dimension of the first display mode 304. Furthermore, modifying a display mode of the virtual content 302 includes expanding the display vertically, horizontally, changing the dimension of the virtual content 302 from two-dimensional to three-dimensional or vice versa, changing the virtual content 302 from a flat display to a curved display, and/or other suitable changes to the display of virtual content from the appearance in the first display mode 304.

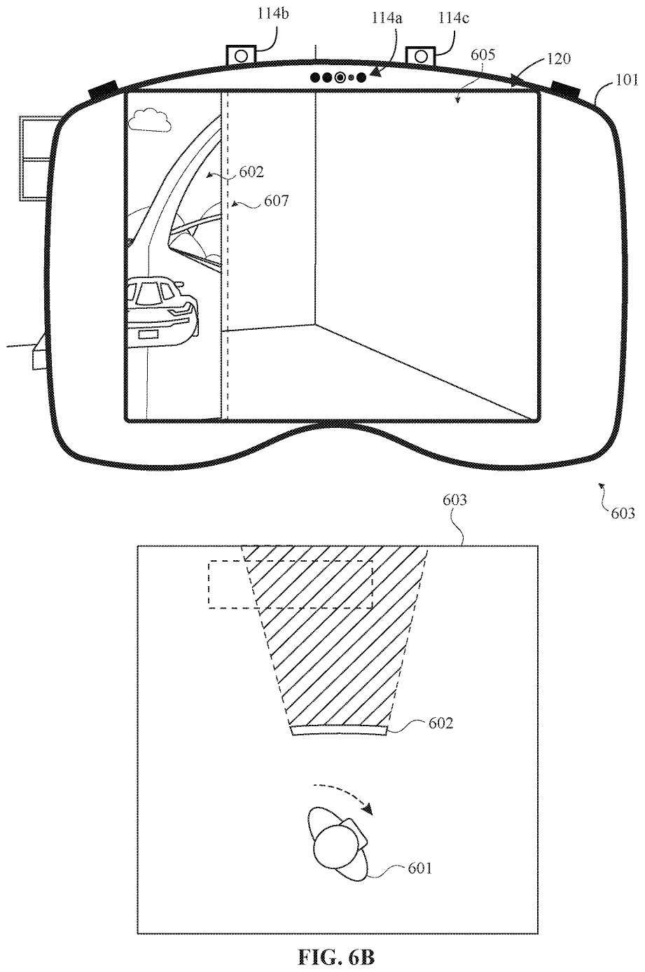

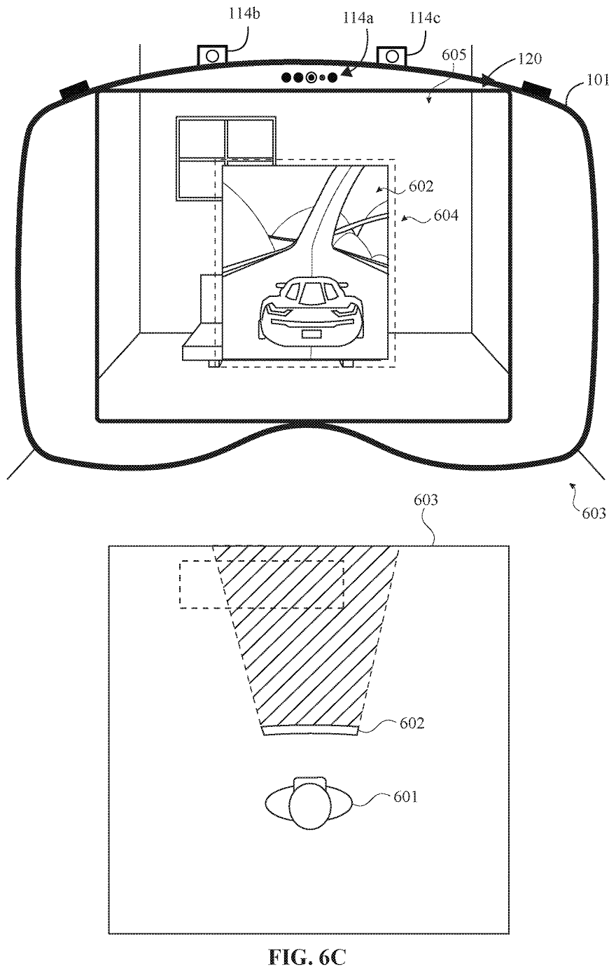

In some examples, the indication corresponding to a request to modify a display mode of the virtual content 302 is an event detected by electronic device 101 related to user 301. In some examples, the indication is an event that could indicate user 301 is experiencing motion sickness, nausea, dizziness, etc. from the virtual content 302 displayed in the first display mode 304. In some examples, the indication is an intentional, manual input (e.g., explicit input), such as a user input to an input device. For example, as shown in FIG. 3A, the indication is received as a user input via a button 306 (e.g., press, press and hold, multiple presses, or a sequence thereof) where, once selected by user 301, indicates the request to modify the display mode. In other examples, the user input is received via a prompt displayed in the virtual content 302 to user 301. For example, the user input is detected at a selectable affordance displayed on a prompt shown on electronic device 101, wherein the selectable affordance selected indicates a condition of the user (e.g., “Are you experiencing motion sickness? Select Yes or No”). The condition of the user, in some examples, is related to user 301 experiencing motion sickness, nausea, dizziness, etc. from elements within virtual content 302. In some other examples, electronic device 101 transitions the display mode automatically (e.g., detects an implicit event). In some examples, electronic device 101 transitions the display mode automatically based on the type of content displayed within virtual content 302 (as described above). In some examples, electronic device 101 transitions the display mode automatically based on user movements within three-dimensional environment 303. In some examples, electronic device 101 transitions the display mode automatically based on a user condition. In some other examples, the indication corresponding to the request to modify a display mode of virtual content 302 is based on a pre-defined motion sensitivity setting on electronic device 101 or on the application playing virtual content 302. In some examples, the pre-defined motion sensitivity setting is a binary user input. In some examples, the pre-defined motion sensitivity setting is a qualitative input. For example, user 301 can indicate on electronic device 101 whether they have a low, medium, or high sensitivity to motion prior to launching virtual content 302. In some examples, electronic device 101 prompts user 301 with the pre-defined motion sensitivity setting when user 301 launches display of the virtual content 302, and the user is able to modify the motion sensitivity setting by interacting with a user interface that includes one or more selectable affordance. The indication corresponding to a request to modify a display mode of the virtual content 302 is described in further detail with reference to FIGS. 6A-6D.

In some examples, a boundary of virtual content 302 expands when user 301 focuses their gaze on the boundary and moves their head in the direction for expansion into the second display mode 307. Gaze tracking as explained herein can be used for user input. For example, when user 301 wants to expand the content at from the left boundary of virtual content 302 in a first display mode 304, user 301 focuses gaze on the left boundary, and when one or more criteria are met corresponding to selection of the left boundary for expansion, user 301 can move their head leftward (e.g., yaw rotation, roll rotation) to expand the left boundary leftward. In some examples, the boundary automatically expands after detecting the user's gaze as the indication to modify the display mode of virtual content 302 without requiring head movement. For example, when user 301 is playing a driving game being shown via virtual content 302, user 301 would want to expand a boundary of the virtual content 302 to help see more or different sections of the environment within the virtual content while turning a corner.

In response to detecting the indication while displaying the virtual content via the one or more display generation components, electronic device 101 transitions virtual content 302 to a second display mode, the transition as shown in FIG. 3B. FIG. 3B illustrates an exemplary transition of the display of virtual content 302 from the first display mode 304 to the second display mode on display 120 of the electronic device. The indication (described above) causes the electronic device 101 to initiate transitioning the display of virtual content 302 from the first display mode 304 to the second display mode. In some examples, the electronic device 101 dynamically transitions virtual content 302 by displaying a transition animation on display 120. In some examples, the animation is shown as arrows to communicate to user 301 how the display mode is changing. In some other examples, the animation is shown as borders of virtual content 302 expanding in the direction of at least the first dimension. For example, an expansion in the direction of at least the first dimension may have a specific rate of change that is observable to the user to slowly transition the content without user 301 experiencing nausea or sickness from the animation motion. In some examples, the rate of change may be 1 mph, 2 mph, 3 mph, etc., or may be defined as an angular rate of change of the user's field of view occupied by the virtual content 302. In another example, the left and right sides of virtual content 302 can grow and/or expand, while the top and bottom of display 120 remain the same size and continue showing areas 305 of the three-dimensional environment 303 above and below virtual content 302. Optionally, the animation is used to transition the virtual content 302 so that user 301 does not experience further nausea or sickness from a quick and sudden change in the display of virtual content of display 120. In some examples, virtual content 302 expands in both the left and right directions at the same time so that virtual content 302 stretches to both edges of display 120 to fill the viewpoint of user 301, but the top and bottom boundaries of virtual content 302 do not expand and the three-dimensional environment 303 is still visible in these areas 305 above and below virtual content 302.

In some examples, the application corresponding to virtual content 302 grows in size and increases immersivity in the three-dimensional environment 303. Additionally or alternatively, the immersion level of virtual content 302 changes by increasing the boundaries (e.g., top and bottom boundaries and/or the left and right boundaries) between the application (e.g., virtual content 302) and the three-dimensional environment 303 with more of the environment displayed in virtual content 302.

For example, as shown in FIG. 3B, electronic device 101 detects an indication via button 306 (e.g., a user interface button) to switch and/or modify the format of the virtual content 302 to a horizontally extending immersion portal. As a result, electronic device 101 transitions the virtual content from a floating window (e.g., first display mode 304) in the three-dimensional environment 303 to a horizontally extending immersion portal (e.g., second display mode 307) in FIG. 3C. In some examples, second display mode is a partially extending immersion portal, where a portion of the three-dimensional environment 303 is still visible surrounding the immersion portal (e.g., virtual content 302).

FIG. 3C illustrates exemplary virtual content displayed in a second display mode according to one or more examples of the disclosure. In the example of FIG. 3C, electronic device 101 displays virtual content 302 in three-dimensional environment 303 in the second display mode 307. It is understood that the display of virtual content 302 is a non-limiting presentation of the display mode of the virtual content and that the virtual content can be possess different spatial properties different from the first display mode 304 within the display of the three-dimensional environment 303.

In some examples, the second display mode 307 refers to a state of the display of virtual content 302, that includes a specific second set of spatial characteristics, different from the first set of spatial characteristics. In some examples, and as described in further detail below, the set of spatial characteristics can be configured to accommodate or display the virtual content when the content is being displayed in a specific type of context. In some examples, the second display mode 307 wraps at least partially around user 301 and is more immersive representation of virtual content 302 compared with the first display mode 304.

In some examples, transition to displaying the virtual content in the second display mode 307 includes expanding/enlarging a size of a first dimension of the virtual content from a first size in the first display mode to a second size in the second display mode. For example, the width of virtual content 302 expands from spanning across 50% of the view of display 120 in the first display mode 304 to expanding across 100% of the view of display 120 in the second display mode 307. In other examples, the height of virtual content 302 expands from spanning vertically across 25% of the view of display 120 to turning into a vertically expanding portal (e.g., virtual content 302 wraps around user vertically so the second size is continuous). In some examples, a first dimension can be a length or a width spatial property, among other properties, specifically set for the first display mode 304. In some examples, the second size in the second display mode 307 is an expansion of the first dimension in the first display mode 304. For example, transitioning to displaying the virtual content in the second display mode 307 includes extending the width of virtual content 302. Additionally and/or alternatively, displaying the virtual content in the second display mode 307 includes extending the height of virtual content 302. In some examples, displaying the virtual content in the second display mode includes maintaining a size of a second dimension of the virtual content when displaying, via the one or more displays, virtual content in the second display mode within the three-dimensional environment. For example, the first dimension of the virtual content 302 is a width and the second dimension of the virtual content 302 is a length, such that changing the display mode from the first display mode 304 to the second display mode includes expanding the width of the virtual content and maintaining the length of the virtual content 302. In another example, displaying the second display mode 307 includes expanding the height of virtual content 302 and maintaining the width. In some examples, electronic device 101 adjusts the display of the virtual content 302 based on one or more preset spatial properties of the first display mode 304 and the second display mode 307. In some examples, the second size in the second display mode 307 includes shrinking or otherwise reducing a size of the first dimension compared to the first display mode 304.

In some examples, the second display mode 307 includes displaying the virtual content that wraps all the way around user 301 in the first dimension (e.g., 360 degrees). In some examples, the second display mode 307 partially wraps around user 301 as illustrated in the top down view. For example, partially wrapping around the user is any value less than 360 degrees, such as 50 degrees, 180 degrees, 270 degrees, etc. For example, transitioning to the second display mode 307 includes expanding the left and right boundaries of virtual content 302 horizontally and/or in the yaw dimension so that the virtual content 302 can be panoramically viewed by user 301, which is shown in FIG. 3C. In some examples, the second display mode 307 includes displaying the virtual content as a larger floating window compared to first display mode 304 on electronic device 101. In some examples, second display mode 307 is a three-dimensional immersion portal. In some examples, a three-dimensional immersion portal is a display of virtual content 302 where the user is completely immersed in virtual content 302. Furthermore, in some examples, the second display mode 307 has a higher immersion level than first display mode 304. In some examples, the amount of virtual content 302 that is displayed (e.g., the amount of three-dimensional environment 303 that is not displayed) is based on an immersion level for the virtual content (e.g., with respect to the representation of the three-dimensional environment 303). For example, increasing the immersion level optionally causes more of the virtual content 302 to be displayed, replacing and/or obscuring more of the three-dimensional environment 303 (e.g., expanding the width or height), and reducing the immersion level optionally causes less of the virtual content 302 to be displayed, revealing portions of the three-dimensional environment 303 that were previously not displayed and/or obscured. In some examples, the level of immersion is increased in the second display mode compared to the first display mode. Moreover, displaying virtual content 302 in second display mode 307 includes displaying virtual content 302 with a second set of spatial properties, different from the first set of spatial properties. In some examples, the second set of spatial properties are unique spatial characteristics of virtual content 302 that are specific to the second display mode 307. In some examples, the second set of spatial properties differ from the first set of spatial properties because the at least a first spatial property is different. For example, a first dimension corresponding to the first spatial property has expanded or shrunken when compared to the corresponding first spatial property of the first set of spatial properties associated with the first display mode described with respect to FIG. 3A. In some examples, the second set of spatial properties include any set of properties unique to the second display mode 307 that differs from the first set of spatial properties and makes virtual content 302 more immersive to user 301. Furthermore, transitioning from the first display mode 304 to the second display mode 307 includes transitioning from a cropped version of the virtual content 302 to a window showing the full content of virtual content 302.

In some examples, while displaying the virtual content in the second display mode 307, electronic device 101 detects an indication corresponding to a request to modify a display mode of the virtual content 302. The indication is any indication described herein. In some examples, the indication is the same as the indication previously explained but occurs when the virtual content 302 is displayed in the second display mode 307, not first display mode 304. In some examples, the indication is different than the previous indication corresponding to a request to modify the display mode from the first to second. In some examples, the indication corresponding to a request to modify a display mode of the virtual content 302 is an event detected by electronic device 101 related to user 301. For example, the indication may be any user input such as a selection of a button or an automatic indication based on the type of content being shown in virtual content 302. Further examples are provided in FIGS. 6A-6D. In some examples, the indication is any event that could indicate user 301 is experiencing motion sickness, nausea, dizziness, etc. from the virtual content 302 displayed in the second display mode 307. In some examples, the indication is an intentional manual (e.g., explicit) input, such as a user input.

In some examples, the indication corresponding to a request to modify the display mode of virtual content 302 includes the motion of elements within virtual content 302 satisfying a threshold value. In some examples, the threshold value is the same for transition between the second and third display modes as for transition between the first and second display modes (e.g., continue motion after the transition). In some examples, the threshold values for transitioning from the first display mode 304 to the second display mode 307 and from the second display mode 307 to the third display mode 308 are different. For example, when the motion of elements within virtual content 302 exceed 500 pixels per second but is below 1000 pixels per second then electronic device 101 transition from the first display mode 304 to the second display mode 307. When the motion of elements within virtual content 302 exceed 1000 pixels per second, then electronic device 101 transitions from the second display mode 307 to the third display mode 308.

FIG. 3D illustrates an example of electronic device 101 worn by a user 301 while transitioning the display of virtual content 302 in three-dimensional environment 303 from second display mode 307 to a third display mode 308. It is understood that the display of virtual content 302 is a non-limiting presentation of the display mode of the virtual content and that the virtual content can be possess different spatial properties different from the second display mode 307 within the display of the three-dimensional environment 303.

For example, as shown in FIG. 3D, electronic device 101 detects an indication to switch and/or modify the format of the virtual content 302 from a horizontally extending immersion portal (e.g., second display mode 307) to a full immersion portal (e.g., wraps around 360 degrees in all directions) (e.g., third display mode 308). As a result, electronic device 101 transitions the virtual content from a horizontally extending immersion portal (e.g., second display mode 307) in the three-dimensional environment 303 to a full immersion portal (e.g., wraps around 360 degrees in all directions) (e.g., third display mode 308). In some examples, third display mode 308 is a fully extending immersion portal, where no portions of the three-dimensional environment 303 are still visible surrounding the virtual content 302. Thus, virtual content 302 becomes the new environment that user 301 is completely immersed in and as user 301 looks around in all angles, only virtual content 302 is visible.

In some examples, like as in FIG. 3D, the indication corresponding to a request to modify the display mode includes electronic device 101 detecting user 301 directing attention (e.g., based on gaze) to a boundary of virtual content 302 (e.g., the top boundary) in the second display mode 307 and, in response to detecting the user holding their gaze at the top boundary for a threshold amount of time, electronic device 101 extends the boundary. For example, when gaze of user 301 is directed at the top boundary of virtual content 302 for at least a threshold amount of time (e.g., 0.1, 0.5, 1, or 3 seconds), then electronic device 101 extends the top boundary of virtual content 302. Indication can be any other indication described herein or below in further detail with more examples with reference to FIGS. 6A-6D. In some examples, the indication initiates the electronic device 101 to transition the display of virtual content 302 from the second display mode 307 to the third display mode 308.

In some examples, after the indication is detected by electronic device 101, electronic device 101 transitions virtual content 302, via the one or more displays, to a third display mode 308 within the three-dimensional environment 303. In some examples, third display mode 308 is different from the first display mode 304 and second display mode 307. For example, transitioning virtual content 302 to the third display mode 308 includes extending at least a second dimension of the virtual content 302. The second dimension is any dimension of the virtual content 302 described herein that is different than the first dimension of the virtual content 302. In some examples, the third display mode 308 refers to a state of the display of virtual content 302, that includes a specific, third, set of spatial characteristics, different from the first set and the second set of spatial characteristics that correspond to the first and second display modes, respectively. In some examples, and as described in further detail below, the set of spatial characteristics can be configured to accommodate or display the virtual content when the content is being displayed in a specific type of context. In some examples, the third display mode 308 wraps entirely around user 301 and is more immersive in virtual content 302 than first display mode 304 and second display mode 307. In some examples, the electronic device 101 dynamically transitions virtual content 302 by displaying a transition animation on display 120. In some examples, as shown in FIG. 3D, the animation is shown as arrows above and below virtual content 302 to communicate to user 301 how the display mode is changing. In some other examples, the animation is shown as borders of virtual content 302 slowly expanding in the direction of at least the second dimension. In another example, when the left and right sides of the virtual content 302 have already expended, the top and bottom boundaries of virtual content 302 can grow or increase to variable amounts to cover the entirety of the three-dimensional environment 303 displayed on electronic device 101. The animation can be any animation described herein.

In some examples, displaying the third display mode 308 includes extending a size of a second dimension of the virtual content 302 from a first size in the second display mode 307 to a second size in the third display mode 308. As explained previously, a second dimension can be any spatial property described herein that is different from the first dimension and is specific to second display mode 307. In some examples, the second size in the third display mode 308 is an expansion of the second dimension in the second display mode 307. In some examples, the second size in the third display mode 308 is a contraction (e.g., shrinking) of the second dimension in the second display mode 307. For example, displaying the third display mode 308 includes extending the width of virtual content 302 while maintaining the height of the virtual content. Alternatively, displaying the third display mode 308 includes extending the height of virtual content 302 while maintaining the width of virtual content 302. In some examples, displaying the third display mode 308 includes maintaining a size of a third dimension of the virtual content when displaying, via the one or more displays, virtual content 302 in the third display mode 308 within the three-dimensional environment 303. For example, the second dimension of the virtual content 302 is a width and the third dimension of the virtual content 302 is a curvature of the display of virtual content 302, so changing the display mode from the second display mode 307 to the third display mode 308 would include expanding the width of the virtual content 302 and maintaining the curvature of the virtual content 302. In another example, displaying the third display mode 308 includes expanding a height of virtual content 302 while maintaining the width. In some examples, electronic device 101 adjusts the display of the virtual content 302 based on one or more preset spatial properties of the third display mode 308.

FIG. 3E illustrates an example of electronic device 101 worn by a user 301 while the display 120 is displaying virtual content 302 in three-dimensional environment 303 after the transition to the third display mode 308. It is understood that the display of virtual content 302 is a non-limiting presentation of the display mode of the virtual content and that the virtual content can be possess different spatial properties different from the first display mode 304 and second display mode 307 within the display of the three-dimensional environment 303.

In some examples, the third display mode 308 completely envelops user 301 once it extends in the second dimension (e.g., the user is 100% immersed in the virtual content such that no part of the three-dimensional environment is visible even when the user moves their viewpoint). For example, transitioning to the third display mode 308 includes expanding the top and bottom boundaries of virtual content 302 vertically so that the virtual content 302 is visible from all angles displayed on display 120 of electronic device 101, which is shown in FIG. 3E. In another example, third display mode 308 includes vertical or horizontal expansion upward and/or downward to fully immerse user 301 in virtual content 302.

In some examples, the third display mode 308 is a wider/larger floating window compared to first display mode 304 and second display mode 307 on electronic device 101. Furthermore, in some examples, the third display mode 308 is more immersive than first display mode 304 and second display mode 307 (e.g., as described above). For example, third display mode 308 is a three-dimensional immersion portal that partially or completely immerses user 301 in virtual content 302. Moreover, displaying virtual content 302 in third display mode 308 includes displaying virtual content 302 with a third set of spatial properties, different from the first set of spatial properties and the second set of spatial properties. In some examples, the third set of spatial properties includes unique dimensions of virtual content 302 that are specific to the third display mode 308. In some examples, the third set of spatial properties differs from the first set of spatial properties and the second set of spatial properties because the at least a first dimension and the second dimension have been shifted. In some examples, the third set of spatial properties includes any set of spatial property unique to the third display mode 308. Furthermore, transitioning from the second display mode 307 to the third display mode 308 optionally includes transitioning from a cropped version of the virtual content 302 to a window showing the full content of virtual content 302. In other examples, transitioning from the second display mode 307 to the third display mode 308 includes transitioning from a smaller display of the virtual content 302 to a larger, more immersive display.

In some examples, third display mode 308 completely immerses user 301 in the virtual content 302 so that the areas 305 between the virtual content 302 and the edge of display 120 are not visible. These areas 305 are explained in further detail with references to FIGS. 8A and 8B and first display mode 304 and second display mode 307.

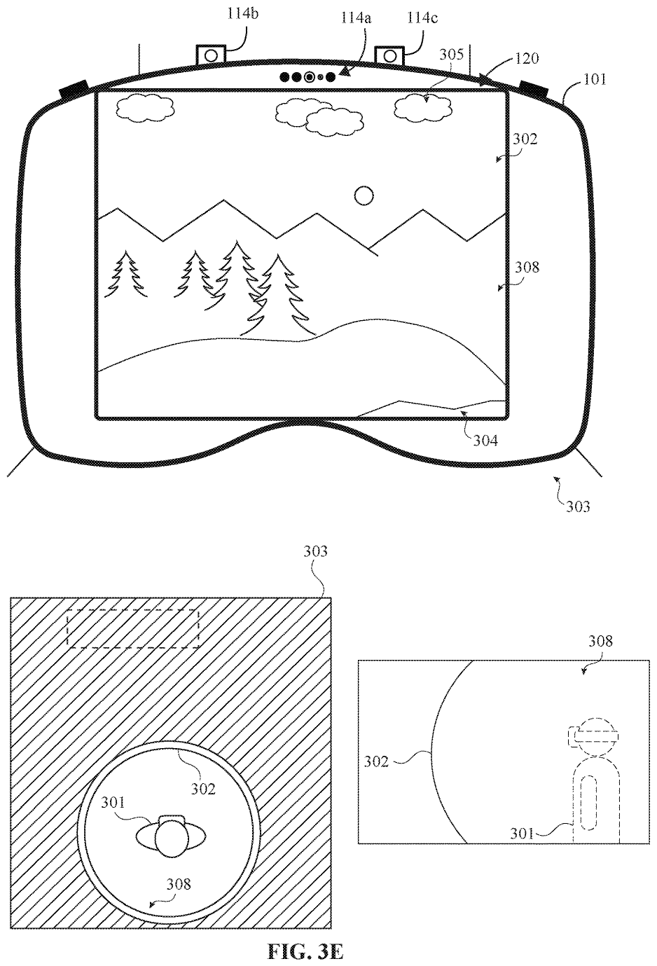

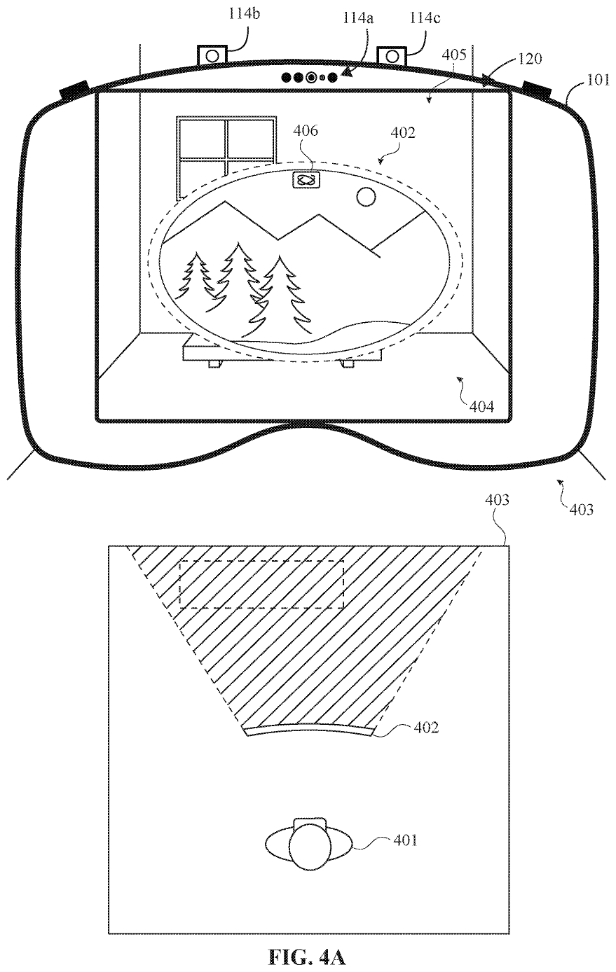

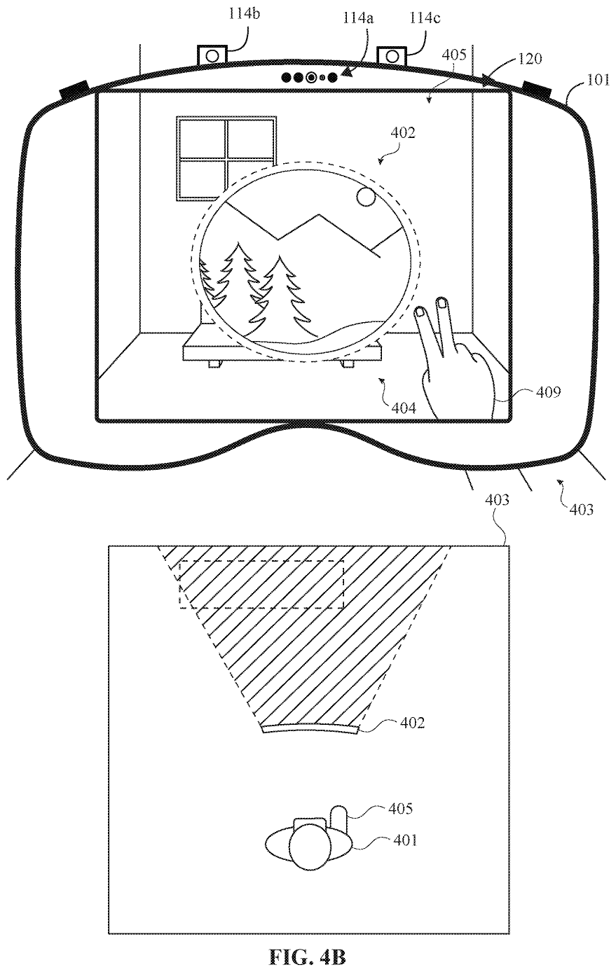

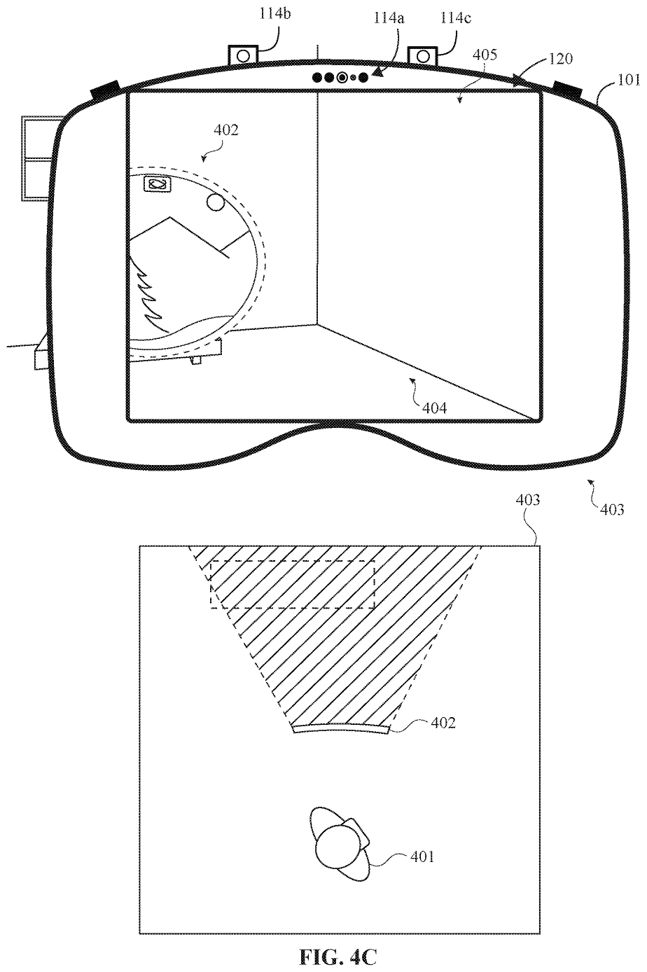

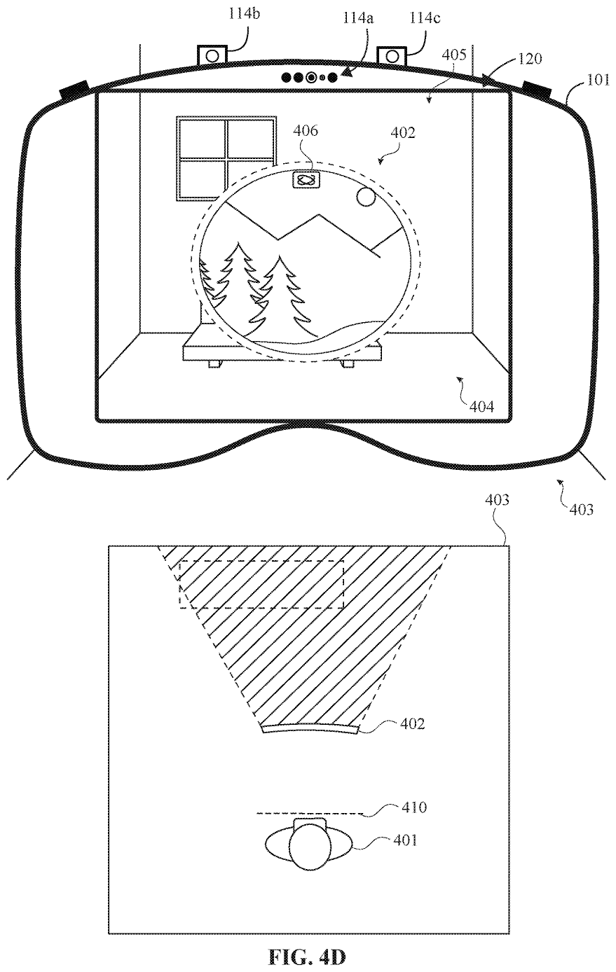

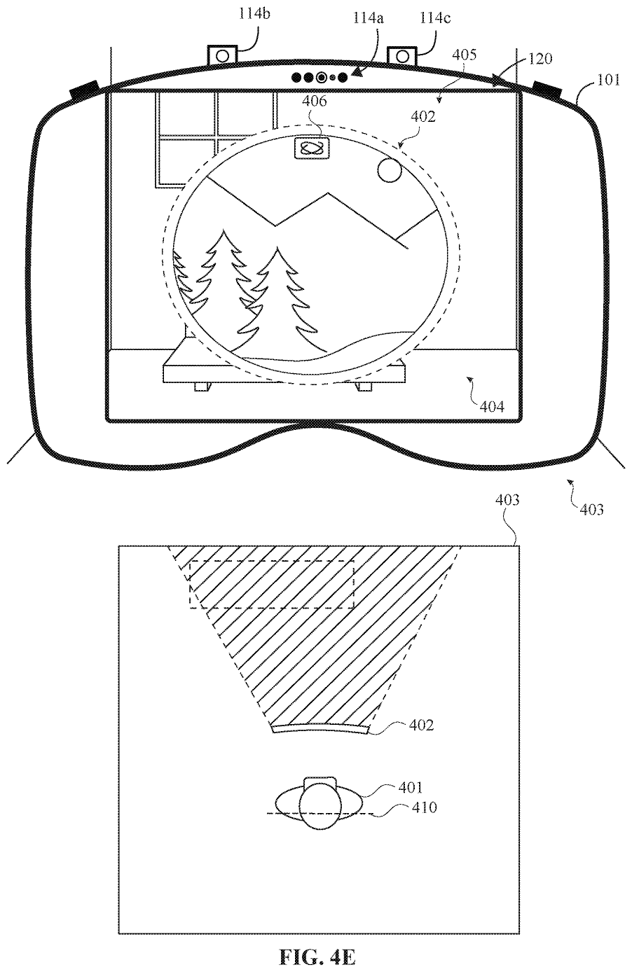

FIGS. 4A-4E illustrate examples of indications corresponding to a request to modify a display mode of the virtual content 402. Virtual content 402 is any virtual content described herein. The figures exemplify a user 401 (e.g., corresponding to user 301) wearing electronic device 101 in a three-dimensional environment 403 that is displaying virtual content 402 in a first display mode 404. Three-dimensional environment 403 is the same as or similar to three-dimensional environment 303 or any other three-dimensional environment described herein. It is understood that the display of virtual content 402 is a non-limiting presentation of the display mode of the virtual content and that the virtual content can have spatial properties different from the first display mode 404 and a second display mode within the display of the three-dimensional environment 403. Though virtual content 402 is displayed in the first display mode 404 throughout FIGS. 4A-4E, virtual content 402 can be in any display mode described herein to trigger the indications described below. Furthermore, any of the examples described can be either the indication corresponding to a request to modify a display mode of the virtual content 402, the difference being what display mode the indication is detected in.

As previously described, detecting an indication corresponding to a request to modify a display mode of the virtual content 402 optionally includes detecting, via the one or more input devices, a user input directed to virtual content 402. In some examples, the user input is detected in response to a prompt displayed on electronic device 101. In some examples, the prompt is a notification to alert the user to select an option on the prompt displayed on electronic device 101, including a pop up window, a selectable button, or any other selectable affordance via a user input to electronic device 101. In some examples, the user input is detected at a selectable affordance displayed on the electronic device 101 and corresponds to a condition of the user. For example, as shown in FIG. 4A, the user input can be detected at a button 406 displayed within virtual content 402. In some examples, button 406 is always displayed within virtual content 402 so that the user can indicate a request to modify a display mode of the virtual content 402 at any time without additional input to first cause display of button 406. In other examples, button 406 appears on display 120 or within virtual content 402 in response to an indication from the user corresponding to a condition of the user. In some examples, an indication from the user corresponding to a condition of the user can be an implicit or explicit input from the user indicating that they are experiencing nausea or sickness from virtual content 402. Once the user input is received, the transition from the current display mode to the next display mode is initiated. Furthermore, user input can be received by the user either manually interacting with display 120 with finger or other gesture input, with gaze directed at a selectable affordance, with verbal (e.g., audio) instruction to select an affordance, or other suitable input by user 401 to electronic device 101. For example, as shown in FIG. 4A, user 401 selects button 406 by directing their gaze at the selectable button, and once the user input is detected at electronic device 101, the device transitions the display from the first display mode 404 to the second display mode. In some examples, the user input is an air pinch while user 301 gazes at the selectable button/affordance. In some examples, user 401 selects button 406 to indicate that they are experiencing motion sickness, nausea, dizziness, etc., from the virtual content 402 displayed on electronic device 101. In some examples, when electronic device 101 receives an indication of a change in a user condition or an indication that the user is experiencing nausea or motion, button 406 can be visually highlighted or visually emphasized. In some examples, electronic device 101 transitions the display mode automatically based on a user condition. In some examples, electronic device 101 detects the user is experiencing nausea and automatically transitions the display mode. In another example, electronic device 101 detects that virtual content 402 could potentially cause motion sickness, and transitions the display mode to anticipate that potential. Moreover, in some examples, sensors and/or cameras on other wearable devices connected to electronic device 101 can detect a user condition. For example, user 401 optionally wears a watch that detects conditions of user 401 that could indicate user 401 is experiencing nausea, such as changes in heartbeat or blood pressure. The device then communicates to electronic device 101 that these conditions detected indicate user 401 is experiencing motion sickness. In response to the communication of the indication to electronic device 101, electronic device 101 transitions the display mode. In other examples, user 401 can indicate on the other device, using a user input (e.g., pressing a button on a watch device), when they feel queasy, and initiate the change in display mode on electronic device 101.

In some examples, button 406 includes a visual indicator (e.g., text) that displays information concerning the transition to the next display mode. For example, the visual indicator asks user 401 if they want to expand or shrink the first dimension (transition display modes). In some examples, button 406, can be a user interface that includes multiple selectable options for the user to customize the display mode. In another example, the visual indicator asks user 401 a binary (e.g., Yes/No) prompt with selectable options. For example, the options include expanding a width of the virtual content 402, expanding a height of the virtual content 402, shrinking the height of the virtual content 402, shrinking the width of the virtual content 402, or other suitable options for the transition between display modes of virtual content 402 described above with respect to FIGS. 3A-3F.

In some examples, the user input that is used to provide an indication to transition between display modes can be a pre-defined input on electronic device 101 that, when detected by the electronic device 101, transitions the virtual content 402 to a different display mode. For example, the pre-defined input that is detected by electronic device 101 (e.g., using the one or more cameras) includes detecting a particular air gesture (e.g., an air pinch). In some examples, detecting an indication corresponding to a request to modify a display mode of the virtual content 402 includes detecting a gesture that is made by the head of the user such as a head shake (e.g., the electronic device 101 detects motion of the user head, and specially a specific form of motion that corresponds to an indication that the user wants to modify the display mode of the virtual content). In some examples, the head shake can include back-and-forth head rotation in the yaw direction or up-and-down head rotation in the pitch direction, among other options. In some examples, detecting an indication corresponding to a request to modify a display mode of the virtual content 402 includes a particular set of gestures that when strung together, indicate the request to change the display mode of virtual content 402.

In some examples, detecting an indication corresponding to a request to modify a display mode of the virtual content 402 includes detecting a pose 409 of a user 401 of the electronic device 101 in the three-dimensional environment 403, as illustrated in the example of FIG. 4B. In some examples, the pose of the user includes a pose of a hand of the user. For instance, in the example of FIG. 4B, pose 409 of user 401 refers to the combination of the position and orientation of the hand (or head or other part) of user 401 in the three-dimensional environment 403. In some examples, pose 409 refers to a specific pose or gesture that user 401 performs within the three-dimensional environment 403 that is pre-defined such that when performed by the user, the pose 409 can be used to indicate the request to modify a display mode of the virtual content 402. For example, pose 409 is a body pose, body orientation, leg pose, or hand pose, like shown in FIG. 4B, that electronic device 101 can detect and recognize as the indication. FIG. 4B illustrates user 401 doing a pose 409 that electronic device 101 recognizes and detects as the indication corresponding to a request to modify a display mode of the virtual content 402 from a first display mode 404 to a second display mode. In further examples, detecting an indication corresponding to a request to modify a display mode of the virtual content 402 includes detecting a change in pose 409 of the user 401 in the three-dimensional environment 403.

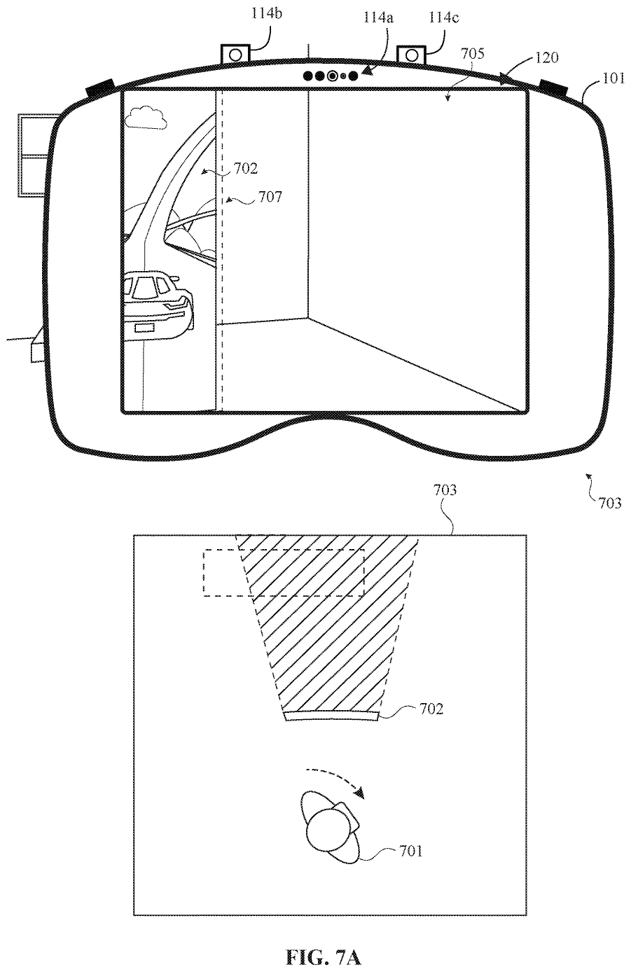

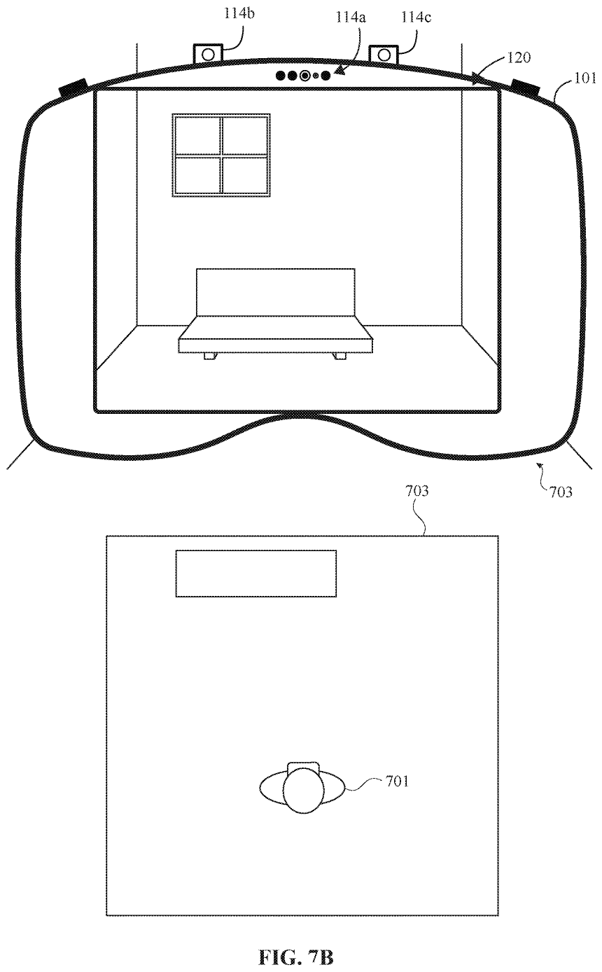

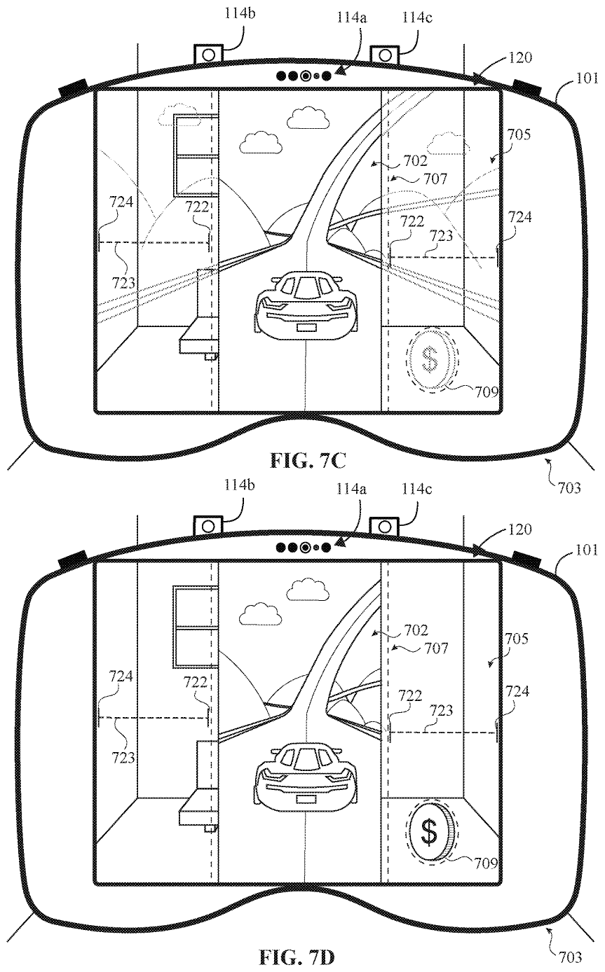

In another example, pose 409 of user 401 can refer to the orientation of user 401 in three-dimensional environment 403. The orientation of user 401 refers to the direction in which user 401 faces while wearing electronic device 101 with respect to the virtual content and/or the three-dimensional environment. In some examples, detecting the indication corresponding to the request to modify a display mode of the virtual content 402 includes detecting an attention of the user directed to the virtual content. In some examples, detecting the indication corresponding to the request to modify a display mode of the virtual content 402 includes detecting an attention of the user directed away from the virtual content 402. For example, detecting an indication corresponding to a request to modify a display mode of virtual content 402 includes detecting that user 401 has changed their orientation toward virtual content 402. In another example, detecting an indication corresponding to a request to modify a display mode of the virtual content 402 includes detecting that user 401 changes their orientation to face away from virtual content 402. As an example, in the example of FIG. 4C, user 401 turns their body away from virtual content 402 (e.g., changed their orientation to face away from virtual content 402) while the content is environment-locked. As a result of detecting this indication, electronic device 101 transitions virtual content 402 from a first display mode 404 to a second display mode. In some examples, electronic device 101 transitions virtual content 402 from a first display mode 404 to a second display mode when the change in orientation of user 401 in the yaw direction satisfies a threshold angle value. This threshold value can be set by an implementor to differentiate between normal head movement, such as 15 degrees, 30 degrees, 45 degrees, or the like. As further explained below with reference to FIGS. 6A-7B, a change in the orientation of the user 401 can alternatively dismiss virtual content 402 from being displayed on electronic device 101 in the three-dimensional environment 403, rather than being used to change the display mode when the change in orientation is above a threshold. This threshold, in some examples, is a directional threshold, a temporal threshold, or both a directional threshold and a temporal threshold. For example, when the change in orientation is above a first threshold value (e.g., 60 degrees of yaw rotation), then the virtual content 402 is dismissed. When the change in orientation is between a first threshold value and a second threshold value (e.g., between 15 degrees of yaw rotation and 60 degrees of yaw rotation), then the virtual content 402 changes display modes. Below the second threshold value of rotation, the electronic device maintains display of content in the same display mode. Further, in another example, to avoid rotation prematurely dismissing the virtual content, the system can require the change in the orientation is above the first threshold value (e.g., 60 degrees of yaw rotation) for a threshold period of time (e.g., for a period of 3 seconds) without returning to the original position for the virtual content to be dismissed. In another example, the system can require the change in the orientation over time. For example, when the rotation is within first threshold value rotation per unit time (e.g., 60 degrees of yaw rotation in 1 seconds without returning to the original position), then the display mode is changed, but when the change in the orientation is above the threshold (e.g., a sharp, quick change), then virtual content 402 is dismissed.

In some examples, a change of display mode can be triggered based on a position of the user within the three-dimensional environment. As illustrated in FIGS. 4D-4E, detecting an indication corresponding to a request to modify a display mode of the virtual content 402 optionally includes detecting that a position of user 401 within the three-dimensional environment 403 is within a threshold distance 410 of the virtual content 402. In some examples, as user 401 moves closer to or further away from the location of virtual content 402 in three-dimensional environment 403, electronic device 101 detects that movement as the indication to change a display mode of virtual content 402. In some examples, the threshold distance 410 can be defined at a distance in the three-dimensional environment 403 between the user 401 and virtual content 402. In some examples, the threshold distance is defined from an initial position of the user. In some examples, the threshold distance is defined from the virtual content, such as 1 meter, 2 meters, 3 meters, etc. For example, as shown in FIG. 4D, a user 401 stands at an initial distance from the location of the virtual content. In FIG. 4E, user 401 has moved in three-dimensional environment 403 from the initial distance toward the virtual content, such that user 401 now stands closer to virtual content 402. For example, FIG. 4E shows the user crosses the threshold distance 410 to allow electronic device 101 to detect the movement as the indication. In some examples, as user 401 moves closer to virtual content 402 in three-dimensional environment 403 and crosses a threshold distance 410, the electronic device 101 modifies the display mode from a first display mode 404 to a second display mode. In another example, as user 401 moves closer to virtual content 402 in three-dimensional environment 403 and crosses another threshold distance (even closer to the virtual content), different than threshold distance 410, the electronic device 101 modifies the display mode from a second display mode to a third display mode 408.

Similarly, as another example, detecting an indication corresponding to a request to modify a display mode of the virtual content 402 includes detecting a movement of user 401 from a first location in the three-dimensional environment 403 to a second location in the three-dimensional environment 403, different from the first location within three-dimensional environment 403. For example, in the examples of FIGS. 4D-4E, the first location can refer to the location of user 401 in FIG. 4D while the second location can refer to the location of user 401 in FIG. 4E. In another example, electronic device 101 can detect that a distance between a first location and second location exceeds a threshold distance before electronic device 101 registers the movement as the indication to change the display mode of the virtual content 402. For example, the minimum distance is 1 meter, 2 meters, 3 meters, etc.

In some examples, detecting the indication corresponding to the request to modify a display mode of virtual content 402 includes detecting one or more physiological states of the user. In some examples, the user 401 of the electronic device 101 can provide an indication of a physiological state of user 401 by providing an input to electronic device 101. Additional and/or alternatively the physiological state of the user can be determined by the electronic device 101 using one or more sensors or external devices. As described above, in some examples, user 401 is communicatively connected to other wearable devices that can detect a condition of user 401 and can send the information to electronic device 101. Furthermore, in some examples, electronic device 101 is equipped with sensors/cameras to detect a condition of user 401. For example, when the condition of user 401 is detected to be experiencing or trending toward sickness or discomfort from virtual content 402 (e.g., a rise in heart rate of user 401), electronic device 101 detects that as the indication to modify the display mode. In some examples, depending on the condition of user 401 detected, electronic device 101 either expands or shrinks the virtual content corresponding to the display mode.

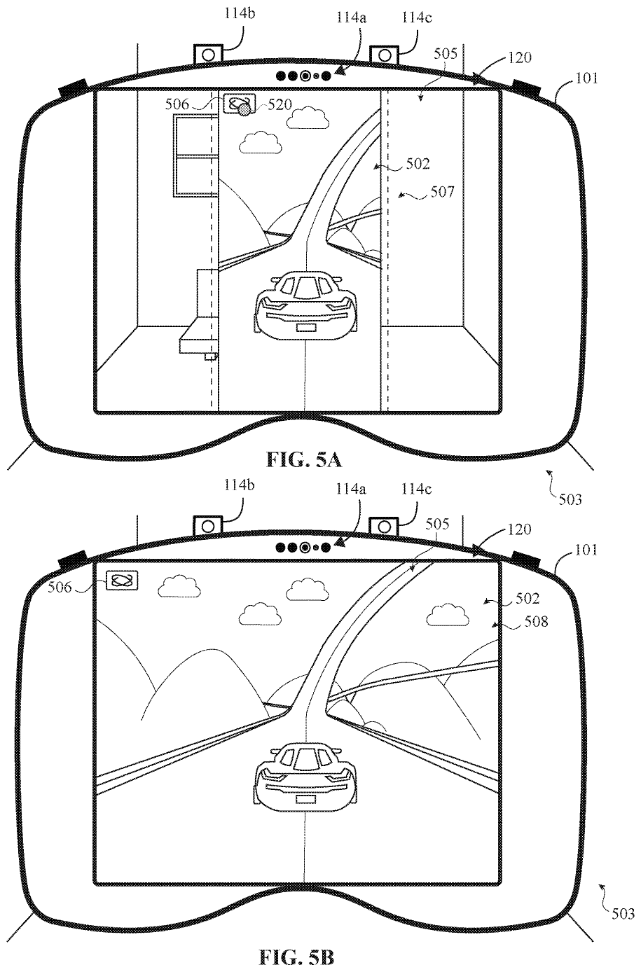

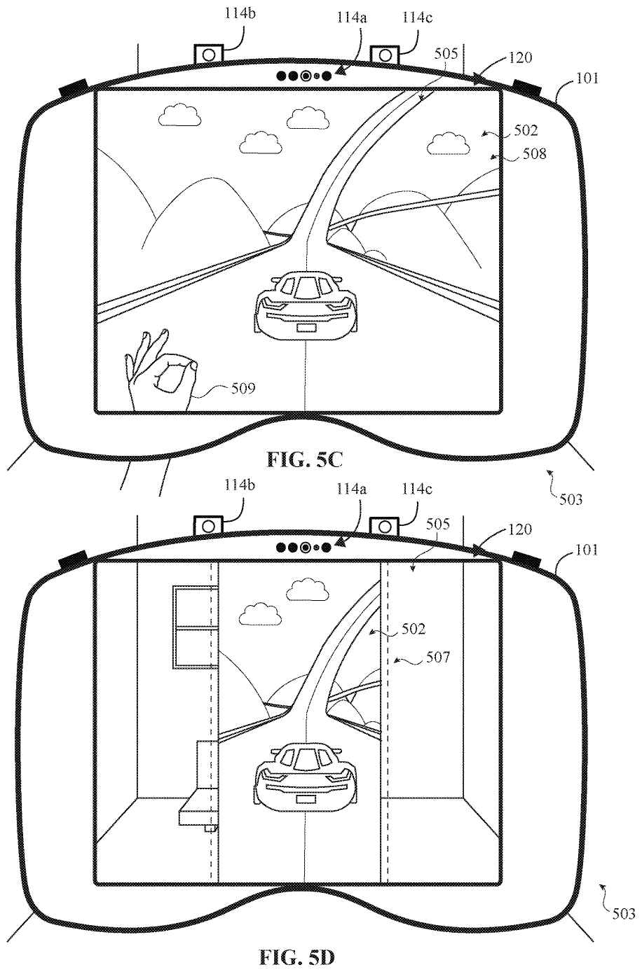

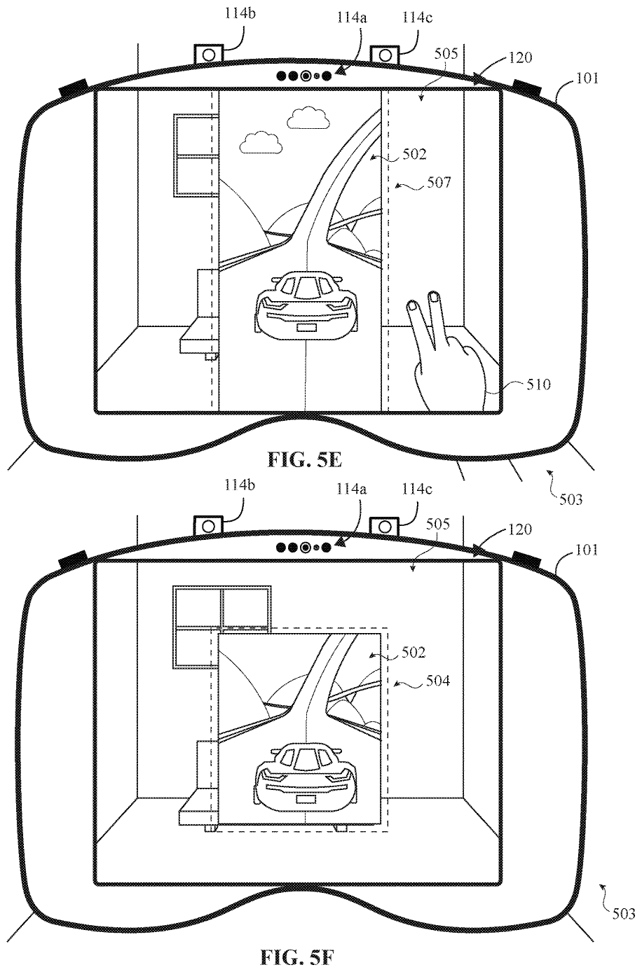

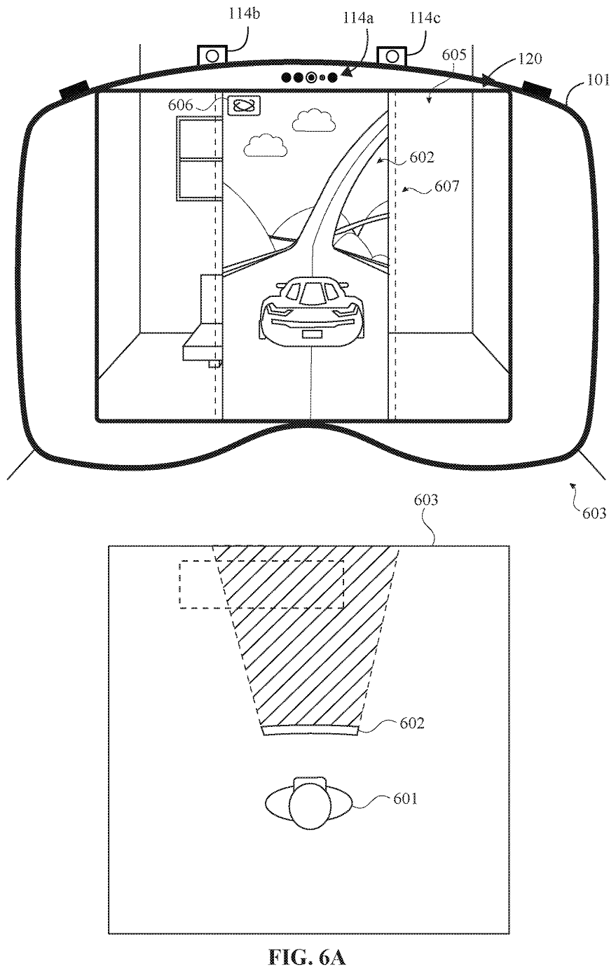

FIGS. 5A-5F illustrate exemplary virtual content 502 as a game application that may impact user condition. In FIG. 5A, illustrated is an example of a gaming application as virtual content 502 in three-dimensional environment 403 in the second display mode 507. FIG. 5A illustrates a gaming application (e.g., virtual content 502) in a vertically-expanding window (e.g., second display mode 507). Once a user input is directed towards button 506 (e.g., corresponding to button 406), electronic device 101 transitions to a full immersion portal (e.g., third display mode 508) which is illustrated in FIG. 5B. It is understood that the display of virtual content 502 is a non-limiting presentation of the display mode of the virtual content and that the virtual content can be possess different spatial properties different from the second display mode 507 and third display mode 508 within the display of the three-dimensional environment 503 (e.g., corresponding to three-dimensional environment 403).

In some examples, such as in FIG. 5A, while displaying the virtual content 502 in the second display mode 507, electronic device 101 detects a gaze 520 of user 501 towards button 506 as the indication corresponding to the request to modify a display mode of virtual content 502. In some other examples, detecting the indication corresponding to a request to modify the display mode of the virtual content 502 includes detecting that the virtual content 502 is a first type of virtual content. A first type of virtual content refers to the type of content that is being displayed by an application (e.g., such as a gaming application). In some examples, a type of content can refer to a particular category and/or genre of content. For instance, in the context of gaming, a first type of content can refer to a racing game, an action game, a sports game and/or other suitable type of video game that includes a greater than a threshold amount of motion. In some examples, the category of content can refer to a movie, motion picture or other media content.

In some examples, the type of content can be embedded in metadata associated with the content such that when electronic device 101 obtains and/or process the metadata, the device can transition the display mode based on the metadata that is associated with the content. For example, as shown in FIG. 5A, electronic device 101 detects that the game application shown as virtual content 502 is a racing game (e.g., through metadata associated with the content) that has a higher chance of causing motion sickness or nausea to a user (e.g., due to the rapid motion of such a game). In some examples, in response to the determination that the video game is a racing game, electronic device 101 changes the display of virtual content 502 from the second display mode 507 to the third display mode 508 as shown in FIG. 5B. In some examples, the first type of virtual content 502 can be a preset setting associated with the content (optionally based on previewing the content or by the developer of the content) or automatically detected based on the motion of the virtual content 502 detected during progression of the game or movie corresponding to the virtual content. In some other examples, the virtual content 502 displayed can have a preset setting indicating when and where button 506 appears when the first type of content is detected in virtual content 502. In some examples, the display mode automatically changes when motion, in the game application or virtual content 502, is detected by electronic device 101 to likely or actually cause motion sickness, nausea, etc.

In some examples, electronic device 101 links the virtual content 502 to the device and predicts when possible events or actions in the virtual content 502 that cause motion are about to be displayed (e.g., occurring soon via the virtual content) and changes the display mode in response. For example, using the virtual content 502 shown in FIG. 5A, electronic device 101 predicts (and/or receives an indication from the game) that the racing game will display a sharp turn to user 501 within a threshold period of time. Electronic device 101 uses the prediction or indication to preemptively change the display mode so that the user can see the sharp turn earlier by increasing the size and/or immersion level of the virtual content. In another example, user 501 can manually inform electronic device 101 (e.g., program or select a preset option on electronic device 101) of a sensitivity to motion. Electronic device 101 uses the indication of motion sensitivity to change the display mode whenever a motion threshold is satisfied (e.g., such as described above). In some examples, the information of sensitivity to motion causes the electronic device to transition between display modes sooner. Optionally, the information of sensitivity to motion causes the electronic device to use different thresholds for transitioning between display modes to enable the transitions to occur sooner and better avoid motion sickness.

In FIG. 5C, illustrated is another example of a gaming application as virtual content 502 in three-dimensional environment 503 in third display mode 508. The example of FIG. 5C illustrates the gaming application (e.g., virtual content 502) transitioning from a full immersion portal (e.g., third display mode 508) to a vertically-expanding window (e.g., second display mode 507 in FIG. 5D) in response to detecting a pose 509 of the hand, such as a pinched gesture from a raised hand or other suitable gesture or pose). It is understood that the display of virtual content 502 is a non-limiting presentation of the display mode of the virtual content and that the virtual content can be possess different spatial properties different from third display mode 508 and the second display mode 507 within the display of the three-dimensional environment 503.

In some examples, as shown in FIG. 5C, while displaying the virtual content 502 in the third display mode 508, electronic device 101 detects another indication corresponding to a request to shrink at least the second dimension of the virtual content 502. The second dimension, in some examples, is the same second dimension that expanded virtual content 502 from the second display mode 507 to the third display mode 508. In some other examples, the second dimension can be a different dimension, different from the first dimension. The indication is any indication described herein that occurs while virtual content 502 is displayed in the third display mode 508. In some examples, detecting an indication corresponding to a request to shrink at least a second dimension of the virtual content 502 includes detecting a second user input, via the one or more input devices, while in the third display mode 508. For example, and as shown in FIG. 5C, the indication is a pose 509 detected by electronic device 101 in the three-dimensional environment 503. As previously explained, in some examples, pose 509 is a specific pose preset in electronic device 101 to indicate the change in the display mode. In some other examples, pose 509 is a specific pose to shrink the display mode rather than expand the display mode (e.g., from the first display mode 504 to the second display mode 507). In some examples, once pose 509 is detected at electronic device 101, electronic device 101 changes the display mode by shrinking the display of virtual content 502 from the third display mode 508 to second display mode 507, and subsequently displaying virtual content 502 in second display mode 507 as shown in FIG. 5D.

In some examples, shrinking the display mode includes shrinking at least a first dimension of the virtual content 502 or shrinking at least a second dimension of the virtual content 502. The first and second dimensions can be any dimension described herein, such as width, height, curvature, etc. of virtual content 502. For example, in FIGS. 5C-5D, the display mode shrinks from the third display mode 508 to the second display mode 507 by shrinking the width of virtual content 502.

FIG. 5E illustrates another example of a gaming application as virtual content 502 in three-dimensional environment 503. In the example of FIG. 5E, gaming application (e.g., virtual content 502) is displayed in a vertically-expanding window (e.g., second display mode 507). After detecting a user input of pose 510 (e.g., an air gesture) performed by the hand of the user, electronic device 101 transitions to a floating window (e.g., first display mode 504) as shown in FIG. 5F. It is understood that the display of virtual content 502 is a non-limiting presentation of the display mode of the virtual content and that the virtual content can be possess different spatial properties different from second display mode 507 and the first display mode 504 within the display of the three-dimensional environment 503.

In some examples, while displaying the virtual content 502 in second display mode 507, electronic device 101 detects an indication corresponding to a request to shrink at least the first dimension of the virtual content 502 in FIG. 5E. The first dimension, in some examples, is the same first dimension that expanded virtual content 502 from the first display mode 504 to the second display mode 507 previously. In some other examples, the first dimension can be any dimension, different from the second dimension. The indication is any indication described herein that occurs while virtual content 502 is displayed in the second display mode 507. In some examples, detecting an indication corresponding to a request to shrink at least the first dimension of the virtual content 502 includes detecting a user input, via the one or more input devices, directed to the virtual content 502 while in the second display mode 507. In some examples, the user input, as shown in FIG. 5E, is a pose 510, different from pose 509, that indicates the change in display mode. As previously explained, in some examples, pose 510 is a specific pose pre-defined in electronic device 101 to indicate the change in the display mode. In some other examples, pose 510 is a specific pose to shrink the display mode rather than expand the display mode (e.g., from the second display mode 504 to the first display mode 504). Once pose 510 is detected at electronic device 101, electronic device 101 changes the display mode by shrinking the display of virtual content 502 from the second display mode 507 to first display mode 504, and subsequently displaying virtual content 502 in first display mode 504 as shown in FIG. 5F.

In some examples, in response to detecting the indication, electronic device 101 transitions the virtual content 502, displayed via the one or more displays, to the first display mode 504 within the three-dimensional environment 503, wherein transitioning the virtual content to the first display mode 504 includes shrinking at least the first dimension of the virtual content. After transitioning, electronic device 101 displays, via the one or more displays, virtual content 502 in the first display mode 504 within the three-dimensional environment 503. Any transition between display modes, includes any animation described herein to show user 501 that virtual content 502 is transitioning to a different display mode.

In some examples, a condition (or an increased likelihood of an onset of the condition) associated with the virtual content is detected as the indication, rather than explicit input from the user. For example, when the virtual content 502 includes to a car chase scene with rapid motions relative to the background environment, electronic device 101 changes the display mode to avoid motion sickness even though the user may or may not be experiencing any symptoms yet.

FIGS. 6A-6C illustrate a sequence of user 601 facing away from virtual content 602 in three-dimensional environment 603 to change the display mode from second display mode 607 to first display mode 604. In the examples of FIGS. 6A-6C, the gaming application (e.g., virtual content 602) transitions from a vertically-expanding window (e.g., second display mode 607) in FIG. 6A to a floating window (e.g., first display mode 604) in FIG. 6C as a result of the change in viewpoint of user 601 shown in FIG. 6B. It is understood that the display of virtual content 602 is a non-limiting presentation of the display mode of the virtual content and that the virtual content can be possess different spatial properties different from second display mode 607 and the first display mode 604 within the display of the three-Dimensional environment 603.

In some examples, detecting an indication corresponding to a request to modify a display mode of the virtual content 602 includes detecting a change in viewpoint of the user 601 with respect to the three-dimensional environment 603. The viewpoint of user 601 refers to the user's field of vision of three-dimensional environment 603 displayed on electronic device 101. The viewpoint of user 601 changes when electronic device 101 detects that the user 601 moves their head and/or moves around three-dimensional environment 603. In some examples, electronic device 101, in response to detecting the change in viewpoint, can modify display of three-dimensional environment 603 to reflect the new viewpoint during and/or after the user movement. In some examples, the computer system transitions from one display mode to another in response to detecting that the change in viewpoint satisfies a threshold change as described herein. For instance, a display mode transition is optionally transitioned in response to detecting a threshold yaw rotation. For example, the threshold can be a 15 degree change, a 30 degree change, a 180 degree change, or another suitable value that electronic device 101 uses to initiate the change in display mode based on the change in viewpoint. For example, electronic device 101 changes the display mode when user 601 turns away from virtual content 602 in three-dimensional environment 603 by at least the threshold rotation. For example, FIG. 6A shows user 601 in three-dimensional environment 603 with virtual content 602 displayed in second display mode 607. In FIG. 6B, electronic device 101 detects rotation of user 601 and correspondingly changes the viewpoint of three-dimensional environment 603, which results in virtual content 602 being partially out of frame of display 120. In some examples, the transition in display mode is performed in response to satisfying one or more criteria to change the display mode (e.g., including a criterion that the change in viewpoint satisfies a threshold change). In response to the determination that the one or more criteria, electronic device transitions virtual content 602 from being displayed in the second display mode 607 to being displayed in the first display mode 604, as illustrated in FIG. 6C.

In some examples, detecting an indication corresponding to a request to modify a display mode of the virtual content 602 includes detecting that user 601 has turned away from virtual content 602 with respect to the three-dimensional environment 603. In other examples, the transition in display mode is caused when the rotation causes a threshold amount of the virtual content to be outside the viewpoint of user 601. For example, depending on how much of virtual content 602 is still visible in three-dimensional environment 603 when the user 601 rotates, electronic device 101 transitions the display mode. In some examples, the threshold amount of virtual content is 50% of the virtual content (e.g., transition when more than half of virtual content 602 is out of view). the threshold amount of virtual content is 25% of the virtual content (e.g., transition when more than half of virtual content 602 is out of view).

In some examples, gestures using head movement can be used to transition between display modes. For example, electronic device 101 can include a pre-defined setting where the display mode changes when the electronic device 101 detects that user 601 moves their head in a specific way or with a specific motion profile. Some example head gestures include nodding (e.g., pitch rotation up and down, optionally more than once), a sharp turn of the head (e.g., satisfies a time and angle threshold), head shake (e.g., yaw rotation left and right, optionally more than once), head roll (e.g., roll rotation left and right, optionally more than once), etc.

FIGS. 7A-7B illustrate another example of a change in viewpoint, but instead of maintaining display of the virtual content 702 in a different display mode, the electronic device 101 ceases display of virtual content 702. FIGS. 7A-7B illustrate user 701 turning away from virtual content 702 in three-dimensional environment 703 (e.g., corresponding to three-dimensional environment 603) and dismissing display of virtual content 702 as a result. It is understood that the display of virtual content 702 is a non-limiting presentation of the display mode of the virtual content and that the virtual content can be possess different spatial properties different from second display mode 707 within the display of the three-dimensional environment 703.

In some examples, as shown in FIG. 7A-7B, in response to detecting that the attention of user 701 is directed away from virtual content 702, electronic device 101 ceases display of virtual content 702 within the three-dimensional environment 703. In some examples, when one or more criteria are satisfied (e.g., including a criterion that the change in attention of user 701 is more than a threshold change), electronic device 101 dismisses display of virtual content 702. In some examples, the change in attention is similar to or the same as the change in viewpoint described above. For example, when user 701 changes their viewpoint by more than a threshold amount (e.g., 10 degrees, 15 degrees, 25 degrees, etc.), electronic device 101 maintains display of the virtual content 702, but changes the display mode for virtual content 702. When user 701 changes their viewpoint more than a second threshold (e.g., 45 degrees, 60 degrees, 75 degrees, etc.), electronic device 101 ceases display of virtual content 702 in three-dimensional environment 703 (despite at least a portion of the virtual content 702 as originally positioned in FIG. 7A being within the user's field of view). In some examples, the one or more criteria also includes a temporal criterion as explained previously. For example, the temporal criterion may avoid transient head rotation from dismissing content by either requiring the rotation be above a threshold speed (rather than just a rotation angle) and/or the rotation be maintained for a threshold period of time. In some examples, the one or more criteria include a criterion that is satisfied when a threshold portion of the virtual content is out-of-frame of display 120. For example, when more than 50%, 60%, 75%, 100%, etc. of virtual content 702 is out-of-frame of display 120, optionally for a threshold period of time (e.g., 3 seconds, 5 second, 10 second, etc.), electronic device 101 ceases display of virtual content 702 in three-dimensional environment 703.

In some examples, electronic device 101 dismisses display of virtual content 702 in three-dimensional environment 703 when electronic device 101 detects an indication that the user is not viewing the display 120 of electronic device 101, electronic device 101 ceases display of virtual content 702 within the three-dimensional environment 703. The indication could be a removal input can be any implicit or explicit user input that indicates the electronic device 101 has been removed from the head of user 701. For example, user 701 selects an “off” button located on electronic device 101, user 701 removes the electronic device from their body (e.g., not wearing electronic device 101 anymore), or any other action performed by user 701 that indicates intent to cease using electronic device 101.

Referring now to FIG. 7C, display 120 of electronic device 101 displays virtual content 702 in the three-dimensional environment 703 in the second display mode 707. An area 705 between the virtual content 702 and the edge of display 120 is visible. It is understood that the display of virtual content 702 is a non-limiting presentation of the display mode of the virtual content and that the virtual content can be possess different spatial properties different from second display mode 707 within the display of the three-dimensional environment 703.

In some examples, display of one or more areas 705 between an edge 722 of the virtual content 702 and an edge 724 of the one or more displays is based on one or more settings associated with virtual content 702. In some examples, the areas 705 are the areas between the edge 722 of virtual content 702 and edge 724 of display 120 (e.g., with distance 723 defining one dimension of one portion of the area). In some examples, there can be one or more areas 705 displayed depending on the display mode of virtual content 702 and what portions of three-dimensional environment 703 are visible. In some examples, areas 705 of the three-dimensional environment between the edge 722 of virtual content 702 and the edge 724 of display 120 are visible in the first display mode 704 and second display mode 707. In some examples, the areas 705 of the three-dimensional environment between the edge 722 of virtual content 702 and the edge 724 of display 120 are not visible in third display mode 708 because there is no visibility of three-dimensional environment 703 outside of virtual content 702 while in third display mode 708. The one or more settings associated with virtual content 702 refers to settings associated with the partial display of aspects of virtual content 702 in areas 705 between an edge portion of the virtual content 702 and an edge of the one or more displays. These settings can include any setting associated with areas 705 such as, an opaqueness setting, a size setting, a color setting, shape setting, etc. In some examples, these one or more settings are used to adjust the display in areas 705 on display 120 of electronic device 101 to show portions of the three-dimensional environment and extended portions or aspects of the virtual content. For example, as shown in FIG. 7C, areas 705 showing three-dimensional environment 703 are partially visible and can display both three-dimensional environment 703 and virtual content 702 simultaneously. Optionally, both three-dimensional environment 703 and virtual content 702 are visible in these areas 705 with different levels of opaqueness/transparency. In some examples, displaying both with different levels of opaqueness/transparency helps alleviate the possibility of user 701 experiencing sickness or nausea due to the motion in virtual content 702. Having the one or more settings be adjustable allows user 701 and/or application developer of virtual content 702 to customize their experience while interacting with virtual content 702. In some examples, three-dimensional environment 703 is completely visible in areas 705 (e.g., as shown in FIG. 7A). In some other examples, three-dimensional environment 703 is partially visible in areas 705 (e.g., as shown in FIG. 7C).

In some examples, and as shown in FIG. 7D, electronic device 101 displays an aspect of virtual content 702. For example, a virtual object 709 is displayed as a separate virtual object in three-dimensional environment 703 without expanding dimensions of the virtual content 702 from what is shown in FIG. 7A. Optionally, electronic device 101 ceases to display virtual object 709 as a part of virtual content 702 (e.g., outside of the window of virtual content 702). In some examples, virtual object 709 is cut out from virtual content 702, and is visible within the areas 705 between the edge 722 of virtual content 702 and the edge 724 of display 120 (e.g., defined in part by distance 723) that show three-dimensional environment 703. Even though virtual content 702 is not displayed in areas 705, virtual object 709 derived from virtual content 702 is still shown as a cutout or floating object within areas 705 between the edge 722 of virtual content 702 and the edge 724 of display 120. In some examples, virtual object 709 derived from virtual content 702 is shown in the same location where it would be displayed if virtual content 702 were extended into areas 705 (e.g., in the second or third display mode). In some examples, virtual object 709 is an object in virtual content 702 that is designated to be visually emphasized or otherwise seen by the user, so even though it is out of view of virtual content 702 in a particular display mode (e.g., the first display mode or the second display mode 707), virtual object 709 can still be seen. In some other examples, virtual object 709 can be highlight or emphasized in any other way to show its presence to user 701.

FIG. 8 illustrates a flow diagram of an example process for transitioning display of virtual content based on user condition according to some examples of the disclosure. In some examples, method 800 begins at an electronic device 101 in communication with one or more displays and one or more input devices. In some examples, the electronic device is optionally a head-mounted display, respectively, similar or corresponding to electronic device 101 of FIG. 1 and electronic device 201 of FIGS. 2A-2B. In some examples, at operation 802, electronic device 101 displays, via display 120 (e.g., one or more displays), virtual content 302 in a first display mode 304 within a three-dimensional environment 303. In some examples, the first display mode 304 displays virtual content 302 as a floating window with the three-dimensional environment 303 visible around the borders of virtual content 302. In some examples, at operation 804, electronic device 101, while displaying virtual content 302 in the first display mode 304, detects an indication corresponding to a request to modify a display mode of the virtual content 302. In some examples, the indication is an implicit or explicit user input, such as a button input or pose. In some examples, at operation 806, in response to detecting the indication, electronic device 101 transitions from the first display mode to a second display mode and displays virtual content 302, via display 120, in a second display mode 307, different from the first display mode 304, within the three-dimensional environment 303. In some examples, in the second display mode 307, virtual content 302 is displayed in a horizontally or vertically extending immersion portal. In some examples, the three-dimensional environment 303 remains visible in areas 705 around virtual content 302. In some examples, displaying transitioning to the second display mode 307 includes extending a size of a first dimension of the virtual content 302 from a first size in the first display mode 304 to a second size in the second display mode 307. In some examples, displaying second display mode 307 includes maintaining a size of a second dimension of the virtual content 302 when displaying, via display 120, virtual content 302 in the second display mode 307 within the three-dimensional environment 303.

In some examples, method 800 further includes, while displaying the virtual content 302 in the third display mode 308, electronic device 101 detects a third indication corresponding to a request to shrink at least the second dimension of the virtual content 302. In some examples, the third indication can be a manual or automatic input detected by electronic device 101. In some examples, in response to detecting the third indication, electronic device 101 transitions the virtual content 302, via the one or more displays, to the second display mode 307 within the three-dimensional environment 303, wherein transitioning the virtual content 302 to the second display mode 307 includes shrinking at least the second dimension of the virtual content 302. In some examples, electronic device 101 displays, via the one or more displays, virtual content in the second display mode within the three-dimensional environment. In some examples, method 800 further includes while displaying the virtual content 302 in the second display mode 307, electronic device 101 detects a fourth indication corresponding to a request to shrink at least the first dimension of the virtual content 302. In some examples, the fourth indication can be a manual or automatic input detected by electronic device 101. In some examples, in response to detecting the fourth indication, electronic device 101 transitions the virtual content 302, via the one or more displays, to the first display mode 304 within the three-dimensional environment 303, wherein transitioning the virtual content 302 to the first display mode 304 includes shrinking at least the first dimension of the virtual content 302. In some examples, electronic device 101 displays, via the one or more displays, virtual content 302 in the first display mode 304 within the three-dimensional environment 303.

Therefore, according to the above, some examples of the disclosure are directed to a method at an electronic device in communication with one or more displays and one or more input devices: displaying, via the one or more displays, virtual content in a first display mode within a three-dimensional environment, while displaying the virtual content in the first display mode, detecting an indication corresponding to a request to modify a display mode of the virtual content, in response to detecting the indication, displaying the virtual content, via the one or more display generation components, in a second display mode, different from the first display mode, within the three-dimensional environment. Displaying the second display mode includes: extending a size of a first dimension of the virtual content from a first size in the first display mode to a second size in the second display mode and maintaining a size of a second dimension of the virtual content when displaying, via the one or more displays, virtual content in the second display mode within the three-dimensional environment.

Additionally or alternatively, in some examples, while displaying the virtual content in the second display mode, electronic device 101 detects a second indication corresponding to a request to extend at least a second dimension of the virtual content, in response to detecting the second indication, transitions the virtual content, via the one or more displays, to a third display mode, different from the first and second display modes, within the three-dimensional environment and transitioning the virtual content to the third display mode includes extending at least the second dimension of the virtual content, and displays, via the one or more displays, virtual content in the third display mode within the three-dimensional environment. Additionally or alternatively, in some examples, extending a size of a first dimension of the virtual content includes extending a width of the virtual content. Additionally or alternatively, in some examples, maintaining a size of a second dimension of the virtual content includes maintaining a height of the virtual content. Additionally or alternatively, in some examples, displaying the virtual content in a second display mode includes transitioning the virtual content from a two-dimensional display to a three-dimensional immersion portal. Additionally or alternatively, in some examples, detecting an indication corresponding to a request to modify a display mode of the virtual content includes detecting, via the one or more input devices, a user input directed to virtual content while in the first display mode. Additionally or alternatively, in some examples, detecting an indication corresponding to a request to modify a display mode of the virtual content includes detecting the user input in response to a prompt displayed on the electronic device. Additionally or alternatively, in some examples, the user input is detected at a selectable affordance displayed on the electronic device, and the selectable affordance is configured to receive an indication from the user corresponding to a condition of the user. Additionally or alternatively, in some examples, detecting an indication corresponding to a request to modify a display mode of the virtual content includes detecting a pose of a user of the electronic device in the three-dimensional environment. Additionally or alternatively, in some examples, detecting an indication corresponding to a request to modify a display mode of the virtual content includes detecting an attention of the user directed to the virtual content. Additionally or alternatively, in some examples, detecting an indication corresponding to a request to modify a display mode of the virtual content includes detecting that a position of the user within the three-dimensional environment is within a threshold distance of the virtual content. Additionally or alternatively, in some examples, detecting an indication corresponding to a request to modify a display mode of the virtual content includes detecting a movement of the user in from a first location in the three-dimensional environment to a second location in the three-dimensional environment, different from the first location. Additionally or alternatively, in some examples, detecting an indication corresponding to a request to modify a display mode of the virtual content includes detecting that the virtual content is a first type of virtual content. Additionally or alternatively, in some examples, detecting an indication corresponding to a request to modify a display mode of the virtual content includes detecting one or more physiological states of the user. Additionally or alternatively, in some examples, detecting an indication corresponding to a request to modify a display mode of the virtual content includes detecting a change in viewpoint of the user with respect to the three-dimensional environment. Additionally or alternatively, in some examples, while displaying the virtual content in the third display mode, detecting a third indication corresponding to a request to shrink at least the second dimension of the virtual content, in response to detecting the third indication, transitioning the virtual content, via the one or more displays, to the second display mode within the three-dimensional environment, and transitioning the virtual content to the second display mode includes shrinking at least the second dimension of the virtual content, and displaying, via the one or more displays, virtual content in the second display mode within the three-dimensional environment. Additionally or alternatively, in some examples, detecting a third indication corresponding to a request to shrink at least the second dimension of the virtual content includes detecting a second user input, via the one or more input devices, directed to the virtual content while in the second display mode. Additionally or alternatively, in some examples, while displaying the virtual content in the second display mode, detecting a fourth indication corresponding to a request to shrink at least the first dimension of the virtual content, in response to detecting the fourth indication, transitioning the virtual content, via the one or more displays, to the first display mode within the three-dimensional environment, and transitioning the virtual content to the first display mode includes shrinking at least the first dimension of the virtual content, and displaying, via the one or more displays, virtual content in the first display mode within the three-dimensional environment. Additionally or alternatively, in some examples, detecting a fourth indication corresponding to a request to shrink at least the first dimension of the virtual content includes detecting a change in a pose of the user in the three-dimensional environment. Additionally or alternatively, in some examples, the virtual content in the first display mode and the second display mode are cropped versions of the virtual content in the third display mode. Additionally or alternatively, in some examples, the method includes detecting a removal input at the electronic device and in response to detecting the removal input, ceasing display of the virtual content within the three-dimensional environment. Additionally or alternatively, in some examples, the method further comprises detecting an attention of the user directed away from the virtual content with respect to the three-dimensional environment and in response to detecting the attention of the user directed away from the virtual content, ceasing display of the virtual content within the three-dimensional environment. Additionally or alternatively, in some examples, displaying the virtual content in the first display mode includes displaying the virtual content with a first set of spatial properties and displaying the virtual content in the second display mode includes displaying the virtual content with a second set of spatial properties, different from the first set of spatial properties. Additionally or alternatively, in some examples, display of an area between an edge portion of the virtual content and an edge of the one or more displays is based on one or more settings associated with virtual content. Additionally or alternatively, in some examples, the one or more settings includes an opaqueness setting. Additionally or alternatively, in some examples, a virtual object cutout from the virtual content is visible within the area between an edge portion of the virtual content and an edge of the one or more displays. Additionally or alternatively, in some examples, adjusting the display of the virtual content based on one or more preset spatial properties of the first display mode and the second display mode. Additionally or alternatively, in some examples, the indication corresponding to a request to modify a display mode of the virtual content is based on a pre-defined motion sensitivity setting.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A method comprising:
at an electronic device in communication with one or more displays and one or more input devices:
displaying, via the one or more displays, virtual content in a first display mode within a three-dimensional environment;
while displaying the virtual content in the first display mode, detecting an indication corresponding to a request to modify a display mode of the virtual content;
in response to detecting the indication, displaying the virtual content, via the one or more displays, in a second display mode, different from the first display mode, within the three-dimensional environment, wherein displaying the second display mode includes:
extending a size of a first dimension of the virtual content from a first size in the first display mode to a second size in the second display mode; and
maintaining a size of a second dimension of the virtual content when displaying, via the one or more displays, virtual content in the second display mode within the three-dimensional environment.

2. The method of claim 1, further comprising:
while displaying the virtual content in the second display mode, detecting a second indication corresponding to a request to extend at least a second dimension of the virtual content; and
in response to detecting the second indication, transitioning the virtual content, via the one or more displays, to a third display mode, different from the first and second display modes, within the three-dimensional environment, wherein transitioning the virtual content to the third display mode includes extending at least the second dimension of the virtual content; and
displaying, via the one or more displays, virtual content in the third display mode within the three-dimensional environment.

3. The method of claim 1, wherein detecting an indication corresponding to a request to modify a display mode of the virtual content includes detecting, via the one or more input devices, a user input directed to virtual content while in the first display mode.

4. The method of claim 1, wherein detecting an indication corresponding to a request to modify a display mode of the virtual content includes detecting that a position of a user within the three-dimensional environment is within a threshold distance of the virtual content.

5. The method of claim 1, wherein detecting an indication corresponding to a request to modify a display mode of the virtual content includes detecting a movement of a user in from a first location in the three-dimensional environment to a second location in the three-dimensional environment, different from the first location.

6. The method of claim 1, wherein detecting an indication corresponding to a request to modify a display mode of the virtual content includes detecting one or more physiological states of a user.

7. The method of claim 1, wherein display of an area between an edge portion of the virtual content and an edge of the one or more displays is based on one or more settings associated with virtual content.

8. The method of claim 1, wherein the indication corresponding to a request to modify a display mode of the virtual content is based on a pre-defined motion sensitivity setting.

9. An electronic device, comprising:
one or more processors;
memory; and
one or more programs, wherein the one or more programs are stored in the memory and configured to be executed by the one or more processors to cause the electronic device to:
display, via one or more displays, virtual content in a first display mode within a three-dimensional environment;
while displaying the virtual content in the first display mode, detect an indication corresponding to a request to modify a display mode of the virtual content;
in response to detecting the indication, display the virtual content, via the one or more displays, in a second display mode, different from the first display mode, within the three-dimensional environment, wherein displaying the second display mode includes:
extend a size of a first dimension of the virtual content from a first size in the first display mode to a second size in the second display mode; and
maintain a size of a second dimension of the virtual content when displaying, via the one or more displays, virtual content in the second display mode within the three-dimensional environment.

10. The electronic device of claim 9, the one or more processors further causing the electronic device to:
while displaying the virtual content in the second display mode, detect a second indication corresponding to a request to extend at least a second dimension of the virtual content; and
in response to detecting the second indication, transition the virtual content, via the one or more displays, to a third display mode, different from the first and second display modes, within the three-dimensional environment, wherein transitioning the virtual content to the third display mode includes extending at least the second dimension of the virtual content; and
display, via the one or more displays, virtual content in the third display mode within the three-dimensional environment.

11. The electronic device of claim 9, wherein detecting an indication corresponding to a request to modify a display mode of the virtual content includes detecting, via one or more input devices, a user input directed to virtual content while in the first display mode.

12. The electronic device of claim 9, wherein detecting an indication corresponding to a request to modify a display mode of the virtual content includes detecting that a position of a user within the three-dimensional environment is within a threshold distance of the virtual content.

13. The electronic device of claim 9, wherein detecting an indication corresponding to a request to modify a display mode of the virtual content includes detecting a movement of a user in from a first location in the three-dimensional environment to a second location in the three-dimensional environment, different from the first location.

14. The electronic device of claim 9, wherein detecting an indication corresponding to a request to modify a display mode of the virtual content includes detecting one or more physiological states of a user.

15. The electronic device of claim 9, wherein display of an area between an edge portion of the virtual content and an edge of the one or more displays is based on one or more settings associated with virtual content.

16. The electronic device of claim 9, wherein the indication corresponding to a request to modify a display mode of the virtual content is based on a pre-defined motion sensitivity setting.

17. A non-transitory computer readable storage medium storing one or more programs, the one or more programs comprising instructions, which when executed by one or more processors of an electronic device, cause the electronic device to:
display, via one or more displays, virtual content in a first display mode within a three-dimensional environment;
while displaying the virtual content in the first display mode, detect an indication corresponding to a request to modify a display mode of the virtual content;
in response to detecting the indication, display the virtual content, via the one or more displays, in a second display mode, different from the first display mode, within the three-dimensional environment, wherein displaying the second display mode includes:
extend a size of a first dimension of the virtual content from a first size in the first display mode to a second size in the second display mode; and
maintain a size of a second dimension of the virtual content when displaying, via the one or more displays, virtual content in the second display mode within the three-dimensional environment.

18. The non-transitory computer readable storage medium of claim 17, the instructions further causing the electronic device to:
while displaying the virtual content in the second display mode, detect a second indication corresponding to a request to extend at least a second dimension of the virtual content; and
in response to detecting the second indication, transition the virtual content, via the one or more displays, to a third display mode, different from the first and second display modes, within the three-dimensional environment, wherein transitioning the virtual content to the third display mode includes extending at least the second dimension of the virtual content; and
display, via the one or more displays, virtual content in the third display mode within the three-dimensional environment.

19. The non-transitory computer readable storage medium of claim 17, wherein detecting an indication corresponding to a request to modify a display mode of the virtual content includes detecting, via one or more input devices, a user input directed to virtual content while in the first display mode.

20. The non-transitory computer readable storage medium of claim 17, wherein detecting an indication corresponding to a request to modify a display mode of the virtual content includes detecting that a position of a user within the three-dimensional environment is within a threshold distance of the virtual content.

21. The non-transitory computer readable storage medium of claim 17, wherein detecting an indication corresponding to a request to modify a display mode of the virtual content includes detecting a movement of a user in from a first location in the three-dimensional environment to a second location in the three-dimensional environment, different from the first location.

22. The non-transitory computer readable storage medium of claim 17, wherein detecting an indication corresponding to a request to modify a display mode of the virtual content includes detecting one or more physiological states of a user.

23. The non-transitory computer readable storage medium of claim 17, wherein display of an area between an edge portion of the virtual content and an edge of the one or more displays is based on one or more settings associated with virtual content.

24. The non-transitory computer readable storage medium of claim 17, wherein the indication corresponding to a request to modify a display mode of the virtual content is based on a pre-defined motion sensitivity setting.
